(19) United States
(12) Patent Application Publication
(10) Pub. No.: US 2012/0041102 A1
(43) Pub. Date: Feb. 16, 2012

(54) NOVEL EPOXY RESIN AND EPOXY RESIN COMPOSITION COMPRISING THE SAME

(75) Inventors: Hyun-Aee Chun, Seongnam (KR); Seung-Han Shin, Seoul (KR); Hyun-Ah Kim, Seoul (KR); Chang-Ho Oh, Seoul (KR); Yun-Ju Kim, Seoul (KR); Sang-Yong Tak, Busan (KR); Myong-Hoon Lee, Jeonju (KR); Tae-Yun Kang, Cheonan (KR)

(73) Assignee: KOREA INSTITUTE OF INDUSTRIAL TECHNOLOGY, Choongcheongnam-do (KR)

(21) Appl. No.: 13/266,126

(22) PCT Filed: Apr. 23, 2010
(86) PCT No.: PCT/KR2010/002567

§ 371 Date: Oct. 24, 2011

(30) Foreign Application Priority Data
Apr. 24, 2009 (KR) 10-2009-0036010
Sep. 24, 2009 (KR) 10-2009-0090649

(51) Int. Cl. C08L 63/10; C08G 59/14; C08K 3/22; C08L 63/00; C08K 3/36; C08L 79/04; C08L 67/02; C08G 59/17; C08K 5/5419

(52) U.S. Cl. 523/456; 525/530; 525/523; 523/400; 523/458; 523/457; 523/466; 525/417; 525/438; 525/529

(57) ABSTRACT

The present invention relates to a novel epoxy resin having improved heat-resistance, thermal expansion properties and processability, and to a thermosetting resin composition comprising the same. To this end, the present invention provides an epoxy resin of Chemical Formula 1 as disclosed in the Description, an epoxy resin composition comprising the same, and a packaging, substrate and transistor formed thereof. When a composition that contains an epoxy resin with a specific side functional group according to the present invention and/or an epoxy resin with a specific core structure is cured, a filler forms a strong chemical bond with the epoxy resin, thereby maximizing filling effects of the filler for the epoxy resin. Moreover, with the specific core structure, heat resistance and heat expansion properties of a cured product are substantially improved (CTE is reduced), and enhanced glass transition properties, strength and processability are demonstrated.

### FIELD OF THE INVENTION

The present invention relates to a new epoxy resin exhibiting improved thermal resistance, thermal expansion property, high glass transition temperature, and processability, and an epoxy resin composition including the same. More specifically, the present invention relates to a new epoxy resin having improved thermal resistance, thermal expansion properties, and processability, and a new thermosetting resin composition with improved thermal resistance, particularly, improved thermal expansion properties (that is, a low Coefficient of Thermal Expansion (CTE)), dimensional stability, and processability at higher temperature comprising the same. The composition of this invention has high glass transition or Tg-less and thus, has superior thermal resistance and mechanical property such as strength.

### BACKGROUND

The coefficient of thermal expansion of a polymer material, specifically, an epoxy resin, is about 50 to 80 ppm/° C. which is several to tens of times greater than those of ceramic materials and metallic materials which are inorganic particles (for example, the coefficients of thermal expansions of silicon and copper are 3 to 5 ppm/° C. and 17 ppm/° C., respectively). Thus, for example, when a polymer material is used with an inorganic or metallic material in the fields of semiconductors, displays, or the like, properties and processability of the polymer material may be significantly limited due to different coefficients of thermal expansion between polymer and inorganic or metallic materials. Furthermore, in the case of semiconductor packaging in which a silicon wafer and a polymer substrate are used adjacently to each other, for example, or when an inorganic barrier layer is coated on a polymer film in order to provide gas barrier properties, product defects, such as the generation of cracks in the inorganic layer, bending of a substrate, peeling of a coating layer, substrate breakage, or the like, may be generated due to a significant CTE-mismatch between constituent elements when a product is subjected to the temperature change.

Due to high CTEs of these polymer materials and large dimensional changes caused by the high CTEs, the development of a next generation IC substrate, a printed circuit board (PCB), packaging, an Organic Thin Film Transistor (OTFT), a flexible display substrate, or the like has been limited. Specifically, in the fields of semiconductor and PCBs, it is currently difficult to secure the design, processability, and reliability of the next generation electronic components requiring high integration, high miniaturization, flexibilization, high performance, or the like, due to polymer materials having very high CTEs, as compared to metal/ceramic materials. In other words, due to high thermal expansion properties of polymer materials at a temperature at which components are processed, defects may be generated during the manufacturing of parts, processes are limited, and there may be problems in securing the design, processability, and reliability of components. Thus, in order to secure the processability and reliability of electronic components, improved thermal resistance, thermal expansion property, and dimensional stability are required.

In order to improve thermal expansion properties (that is, lower coefficient of thermal expansion) of a polymer material, for example, until now, methods for (1) preparation of epoxy resin composites with inorganic particles (inorganic filler) and/or fabric or (2), synthesis of a new epoxy resin with low CTE have generally been used.

When an epoxy resin is combined with a filler (inorganic particles) in order to improve thermal expansion properties of epoxy resin, sufficient low CTE composite may be obtained only when a large amount of a silica filler having a size of about 2 to 30 μm has to be used. However, a large amount of filler in epoxy resin may bring about deterioration in processability and properties of electronic components. That is, a large amount of filler decreases fluidity and brings about the formation of problematic voids when narrow gaps are filled. In addition, the addition of filler exponentially increases the viscosity of a material. Furthermore, due to the miniaturization of a semiconductor structure, the size of filler particles is decreased. However, decrease in fluidity (an increase in viscosity) can become much more severe if a filler particles of 1 μm or less are used. In the meantime, composite with the large size filler may have difficulty in filling an area to which the composite is applied. When a composite of an organic resin and a fabric is used, it is difficult not only to reach CTE values of 10 ppm/° C. or less but also to reduce CTE in the thickness direction(z-axis).

As lead-free materials with the high melting point which substitute for lead-containing solders are used, the reflow temperature is increased to be in a range of 260 to 275° C., which is higher by several tens of degrees than the reflow temperature in the related art, when semiconductors are mounted. Thus, there is need for the development of a material with a high glass transition temperature, such that excellent reflow properties may be obtained at high temperatures, compared to related-art materials.

In addition, an increase in the glass transition temperature of materials is also helpful in order to show the low thermal expansion at temperatures at which electronic parts are processed. The CTE and dimensional change of the polymer system drastically increase as the temperature passes through the glass transition temperature (Tg), in which polymer show the thermal transition from a glass state to a rubbery state. As shown in FIG. 1, in the polymer system, the CTE (α2) in the temperature range of over glass transition temperature (T>Tg), is significantly increased, compared to the CTE (α1) in the temperature range of below the glass transition temperature (T<Tg). In general, the α2 value is higher than the α1 value by several hundred percent. Due to thermal properties of the polymeric material system, the polymer system may show a discrete and significant dimensional change before and after the glass transition temperature. For example, in the case of epoxy curing products, the CTE (α1) in the temperature range of below the glass transition temperature is 50 to 80 ppm/° C., while the CTE (α2) in the temperature range of over glass transition temperature increases to 200 ppm/° C. Accordingly, the dimensional change at temperatures of Tg or higher significantly increases, compared to that at temperatures of below Tg. As shown above, thermal expansion properties of a polymer system before and after the Tg change significantly, thereby causing a significant dimensional change.

Thus, there is need for the development of a new polymer composition (composite) which exhibits improved thermal resistance and thermal expansion properties in order to solve problems arising from high CTE and low thermal resistance and processability, etc, and minimizes dimensional changes according to changes in temperature. In addition, the thermal resistance and/or thermal expansion properties of a polymer may be improved by designing a polymer system that exhibits a high glass transition temperature or furthermore, glass transition temperature-less (Tg-less) property.

### SUMMARY OF THE INVENTION

An aspect of the present invention provides a new epoxy resin exhibiting improved thermal resistance, thermal expansion properties, dimensional stability, and processability.

Another aspect of the present invention provides an epoxy resin composition with improved thermal resistance, thermal expansion properties, dimensional stability, mechanical strength, and processability.

Another aspect of the present invention provides an epoxy resin composition, which exhibits a high glass transition temperature (Tg), and/or Tg-less behavior.

According to an aspect of the present invention, there is provided an epoxy resin of the following Formula 1:

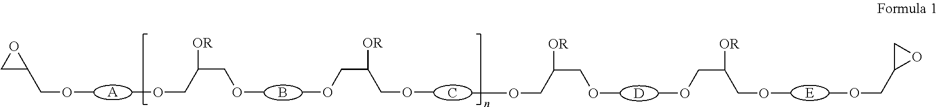

where the core structures of A to E are each independently selected from the group consisting of a bisphenol A-based structure, a biphenyl-based structure, a naphthalene-based structure, a cardo-based structure, an anthracene-based structure, a dicyclopentadiene-based structure, a polyaromatic structure, and a liquid crystal-based compound structure, and are identical to or different from each other and a side functional group R is selected from the group consisting of an epoxy group, a vinyl group, an allyl group, a carboxyl group, an acid anhydride group,

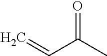

(the terminals thereof being connected), and

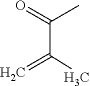

(the terminals thereof being connected); or the core structures of A, C, and E are identical to each other and the core structures of B and D are identical to each other, the core structures of A, C, and E and those of B and D are different, each being independently selected from the group consisting of a bisphenol A-based structure, a biphenyl-based structure, a naphthalene-based structure, a cardo-based structure, an anthracene-based structure, a dicyclopentadiene-based structure, a polyaromatic structure, and a liquid crystal-based compound structure and a side functional group R is selected from the group consisting of hydrogen, an epoxy group, a vinyl group, an allyl group, a carboxyl group, an acid anhydride group,

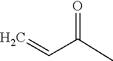

(the terminals thereof being connected), and

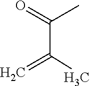

(the terminals thereof being connected), where n is an integer of 0 to 100.

According to another aspect of the present invention, there is provided an epoxy resin composition, including an epoxy resin of the present invention; a curing agent; and at least one filler selected from the group consisting of inorganic particles and a fiber.

According to another aspect of the present invention, there are provided a packaging, a substrate, and a transistor, which are formed of the epoxy resin composition according to the present invention.

An epoxy resin including a specific side functional group according to the present invention and/or an epoxy resin having a specific core structure, in curing of a composition including the same, allow a filler to be strongly chemically bound to the epoxy resin, and thus the effects by the filler for the epoxy resin may be maximized and the specific core structure may greatly enhance the thermal expansion properties of a cured product (a decrease in CTE) and high glass transition (or Tg-less) and thus allow the cured product to exhibit improved thermal resistance, mechanical strength, and processability.

### DESCRIPTION OF DRAWINGS

The above and other aspects, features and other advantages of the present invention will be more clearly understood from the following detailed description taken in conjunction with the accompanying drawings, in which:

FIG. 1 is a graph illustrating the relationship between a glass transition temperature and coefficients of thermal expansion (CTE) in a polymer system;

FIG. 2 is a view showing that a hydroxyl group in an epoxy resin is modified;

FIG. 3 is a view illustrating a concept that thermal expansion property of a resin composition is improved by a naphthalene-based epoxy resin according to an embodiment of the present invention;

FIG. 4 is a graph illustrating changes in storage modulus of a polymer system with a glass transition temperature and Tg-less system;

FIG. 5 is a graph illustrating dimensional changes with the increase of temperature of thermosetting epoxy resin compositions prepared in Example and Comparative Examples;

FIG. 6 is a graph illustrating coefficients of thermal expansion (CTEs) of thermosetting epoxy resin compositions prepared in Example and Comparative Examples at temperatures below the glass transition temperature;

FIG. 7 is graphs illustrating thermal properties changes of resin compositions in Example 5;

FIG. 8 is graphs illustrating thermal properties changes of resin compositions in Example 6;

FIG. 9 is graphs illustrating thermal properties changes of resin compositions in Comparative Example 3;

FIG. 10(a) is graphs illustrating changes in storage moduli of resin compositions in Examples 5 and 6; and

FIG. 10(b) is graphs illustrating changes in tan δ of resin compositions in Examples 5 and 6.

Exemplary embodiments of the present invention will now be described in detail with reference to the accompanying drawings.

### DETAILED DESCRIPTION

As described above, the present invention is proposed to provide a new epoxy resin having improved thermal expansion properties, glass transition temperature, processability, and mechanical strength with increasing of temperature and an epoxy resin composition including the same. Hereinafter, a new epoxy resin according to the present invention and an epoxy resin composition including the same will be described.

An epoxy resin having improved thermal expansion properties and processability

According to an embodiment of the present invention, there is provided a new epoxy resin of the following Formula 1.

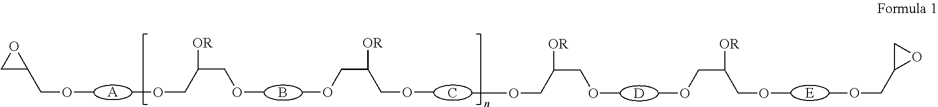

Where the core structures of A to E are each independently selected from the group consisting of a bisphenol A-based structure, a biphenyl-based structure, a naphthalene-structure, a cardo-based structure, an anthracene-based structure, a polyaromatic structure, and a liquid crystal-based compound structure, and are identical to or different from each other and a side functional group R is selected from the group consisting of an epoxy group, a vinyl group, an allyl group, a carboxyl group, an acid anhydride group,

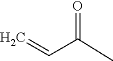

(the terminals thereof being connected), and

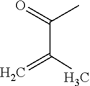

(the terminals thereof being connected); or

the core structures of A, C, and E are identical to each other and the core structures of B and D are identical to each other, the core structures of A, C, and E and those of B and D are different, each being independently selected from the group consisting of a bisphenol A-based structure, a biphenyl-based structure, a naphthalene-based structure, a cardo-based structure, an anthracene-based structure, a polyaromatic structure, and a liquid crystal-based compound structure and a side functional group R is selected from the group consisting of hydrogen, an epoxy group, a vinyl group, an allyl group, a carboxyl group, an acid anhydride group,

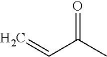

(the terminals thereof being connected), and

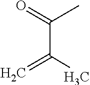

(the terminals thereof being connected).

It is to be understood that the terms “core structures which may be different” and “structures which are different from each other” mean a case in which the core structures are different from each other, such as naphthalene-based and anthracene-based structures, a case in which even the naphthalene structures are different from each other as in the following Formulas (1-5) and (1-6), and a case in which the positions of carbon to be bound in the naphthalene structure are different from each other.

An epoxy resin having a specific side functional group selected from “the group consisting of an epoxy group, a vinyl group, an allyl group, a carboxyl group, an acid anhydride group,

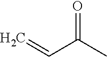

(the terminals thereof being connected), and

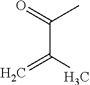

(the terminals thereof being connected) and/or an epoxy resin having a specific core structure of the Formula 1 allow a filler to be strongly chemically bound to the epoxy resin during curing of the epoxy group, and thus the effects by filler for the epoxy resin may be maximized and characteristics of the specific core structure greatly enhance the thermal resistance and allow the composition to exhibit improved thermal expansion properties (low CTE), glass transition behavior (or Tg-less), mechanical strength, and processability.

Among the core structures of Formula 1 in the epoxy resin, the bisphenol A-based structure may be any one having a bisphenol A structure, is not limited thereto, but may be, for example, a bisphenol A structure of the following Formula (1-1) or (1-2).

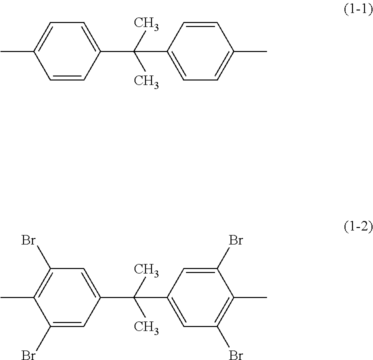

Among the core structures of Formula 1 in the epoxy resin, the biphenyl-based structure may be any one having a biphenyl structure, is not limited thereto, but may be, for example, a biphenyl structure of the following Formula (1-3) or (1-4).

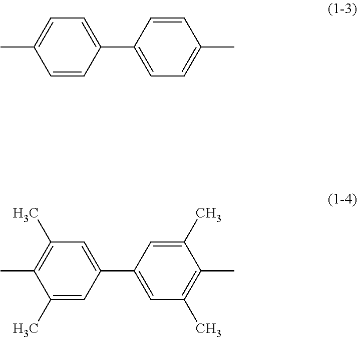

Among the core structures of Formula 1 in the epoxy resin, the naphthalene-based structure is not limited thereto, but may be, for example, a naphthalene structure of the following Formula (1-5) or (1-6),

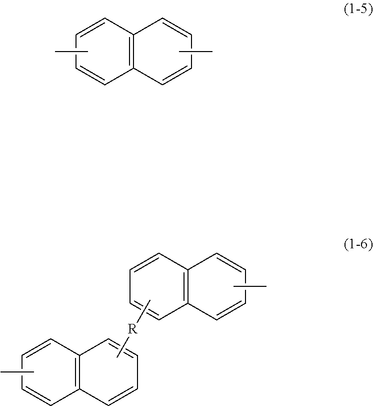

(where R in Formula 1-6 may be a simple bond or a C1 to C5 alkanediyl group, and preferably may be a C1 to C3 alkanediyl group.)

A linking site to a naphthalene ring in the Formulas (1-5) and (1-6) and a binding site between naphthalene rings in Formula (1-6) are not specified, meaning that they may be linked and bound to any carbon position in the naphthalene ring. Although the linking and binding sites are not limited thereto, it is to be understood that they include all the cases in which the sites are linked to 1,2-, 1,3-, 1,4-, 1,5-, 1,6-, 1,7-, 2,3-, 2,6-, and 2,7-carbon positions in Formulas 1-5. In addition, it is to be understood that the sites include all the cases in which the sites are linked to any parts of two naphthalenes, such as linking to 2,6-binaphthalenyl-7,7′-carbon position and to 1,1-binaphthalenyl-2,2′-carbon position.

Among the core structures of Formula 1 in the epoxy resin, the cardo-based structure may be any one having a cardo structure, is not limited thereto, but may be, for example, a cardo structure of the following Formula (1-7) or (1-12).

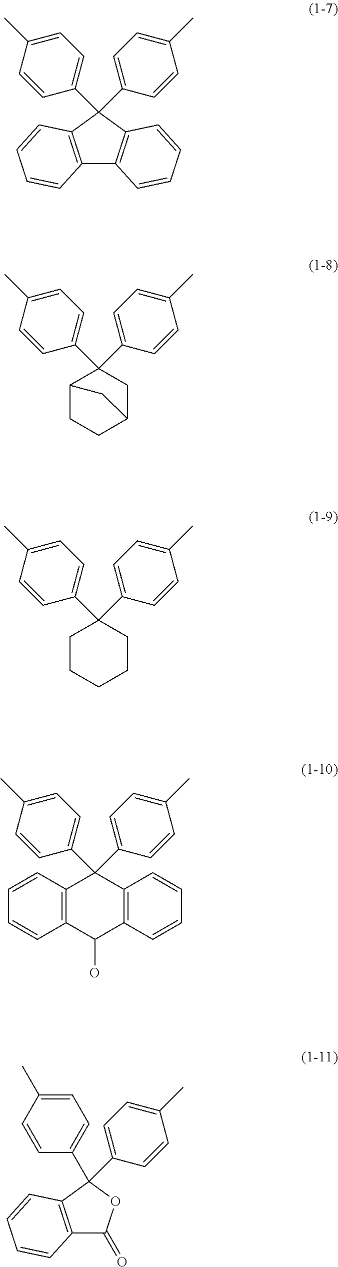

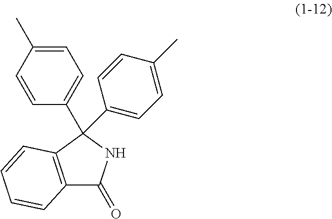

Among the core structures of Formula 1 in the epoxy resin, the anthracene-based structure may be any one having an anthracene structure, is not limited thereto, and may be, for example, an anthracene structure of the following Formula (1-13).

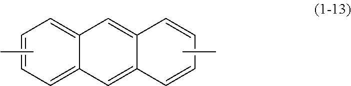

The n value in Formula 1 is an integer of 0 to 100. If the molecular weight of an epoxy resin is increased due to an increase in number of repeating units, the cross-linking density may be reduced, and it may be difficult to process an epoxy material as the viscosity of the resin increases. Thus, the number of repeating units may be preferably 20 or less, more preferably 10 or less, further preferably 5 or less, still further preferably 2 or less, and most preferably 0.

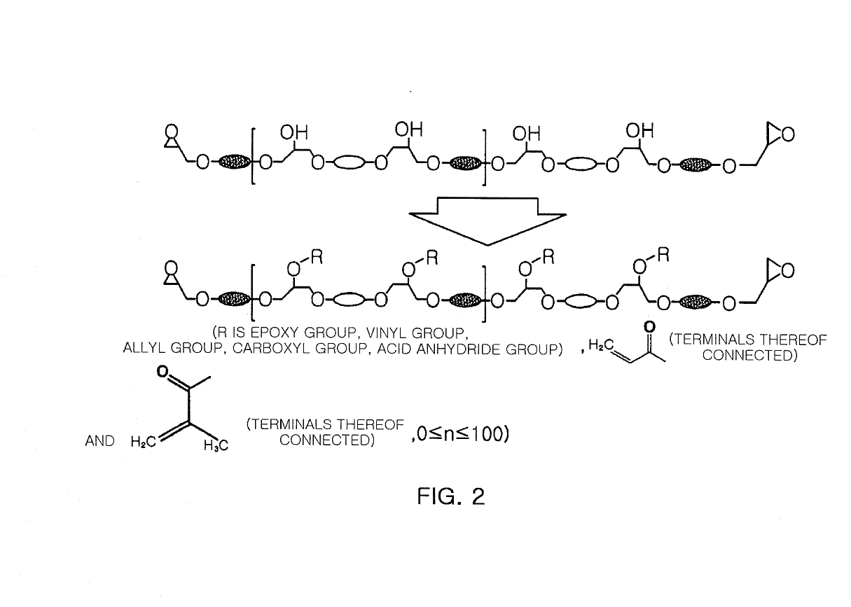

An R side group present in a main chain of the epoxy resin in Formula 1 may be hydrogen or a specific functional group, as shown in FIG. 2 depending on the core structure. Specifically, the specific side functional group R may be at least one functional group selected from the group consisting of an epoxy group, a vinyl group, an allyl group, a carboxyl group, an acid anhydride group,

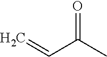

(the terminals thereof being connected), and

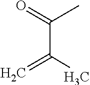

(the terminals thereof being connected).

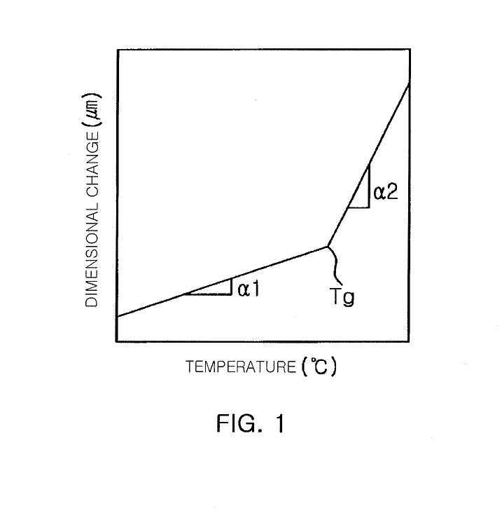

Specifically, when the core structures A to E in FIG. 1 are each independently selected from the group consisting of a bisphenol A-based structure, a biphenyl-based structure, a naphthalene-based structure, a cardo-based structure, an anthracene-based structure, a polyaromatic structure, and a liquid crystal-based compound structure, and are identical to or different from each other, the side functional group R may be selected from the group consisting of an epoxy group, a vinyl group, an allyl group, a carboxyl group, an acid anhydride group,

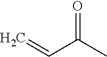

(the terminals thereof are connected), and

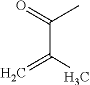

(the terminals thereof are connected).

When the core structures of A, C, and E are identical to each other, the core structures of B and D are identical to each other, and the core structures of A, C, and E and those of B and D are different, each being independently selected from the group consisting of a bisphenol A-based structure, a biphenyl-based structure, a naphthalene-based structure, a cardo-based structure, an anthracene-based structure, a polyaromatic structure, and a liquid crystal-based compound structure, a side functional group R may be selected from the group consisting of hydrogen, an epoxy group, a vinyl group, an allyl group, a carboxyl group, an acid anhydride group,

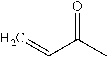

(the terminals thereof being connected), and

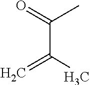

(the terminals thereof being connected).

An epoxy resin having the specific side functional group may be prepared by deprotonation of a proton (H+) in hydroxyl groups in a main chain of the epoxy resin using a base and followed by reaction with epichlorohydrin, (meth)acryloyl halide, allyl halide, an acid anhydride, or the like. At this time, K2CO3, KOH, NaOH, NaH, triethyl amine, diisopropylethylamine, tetraethylammonium halide, triethylbenzylammonium halide, or the like may be used as the base.

When a cured product is prepared by using a composition including an epoxy resin that has a specific side functional group and/or a specific core structure according to an embodiment of the present invention, the glass transition temperature of the cured product to be manufactured is increased and the thermal resistance thereof is improved. This is because a filler to be described below forms composite with the epoxy resin, by a chemical bond of the epoxy resin with a reactive functional group of the filler, in a filled state.

In addition, in a thermosetting resin composition including the epoxy resin, thermal motions of the epoxy polymer are restrained with increasing of temperature, and thus the thermal transition, that is, the glass transition behavior is inhibited, weakened, or decreased, and/or not exhibited. Thus, the resin composition of the present invention exhibits excellent strength, even at a temperature range over the glass transition temperature, and specifically, improved thermal and mechanical strength properties. A composition including the epoxy resin of the present invention may be applied to a substrate which is thinner than the related-art substrates due to its excellent strength at high temperatures, and thus, may be applied to thickness slimming and miniaturization technology of electronic products.

In the meantime, for related-art processes, when an epoxy resin having a high glass transition temperature is used in order to be appropriate at the high temperatures processing, a highly rigid aromatic epoxy structure is frequently employed in order to increase the glass transition temperature of the epoxy resin. Accordingly, it may be difficult to process this epoxy resin, because the resin with the rigid unit may not be well dissolved into solvents and melted. However, when a new epoxy resin according to the present invention is used, a cured composite system shows the high glass transition temperature (Tg) even though Tg of the epoxy resin itself is not high. Thus, a resin of this invention is well dissolved in solvents and melted and thus it is easy to prepare a cured product and its processability is also improved and therefore.

In general, the hydroxyl group (OH group) of the epoxy resin is disadvantageous in that the group increases the dielectric constant and water absorption of the resin. However, when a side functional group —OR of the epoxy resin is converted to a specific side functional group other than the hydroxyl group, the concentration of the OH group in the epoxy resin is decreased and thus the epoxy resin is advantageous in that it decreases the dielectric constant and water absorption. In addition, hydrogen bonds between epoxy molecules are eliminated, and thus, the viscosity of the epoxy resin is decreased, thereby improving the processability. Furthermore, a filler chemically bound to a main chain of the epoxy resin may serve as a crosslinking point and thus the degree of cure of the epoxy resin as a whole is increased, thereby improving physical properties of a cured product, such as thermal resistance properties, modulus, or the like.

According to another embodiment of the present invention, epoxy resins in which the core structures of A, C, and E are identical to each other, those of B and D are identical to each other and the core structures of A, C, and E and those of B and D are different naphthalene-based units in formula 1 (hereinafter, they are referred to as ‘naphthalene-based epoxy resins’) are provided. In this case, the side functional group R may be selected from the group consisting of hydrogen, an epoxy group, a vinyl group, an allyl group, a carboxyl group, an acid anhydride group,

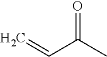

(the terminals thereof being connected), and

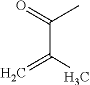

(the terminals thereof being connected).

In addition, n in Formula 1 is an integer of 0 to 100, preferably 0 to 10, more preferably 0 to 5, still more preferably 0 to 2, and most preferably 0. When n is more than 100, it is not preferable in that the processability is deteriorated and the degree of crosslinking is reduced. A naphthalene-based epoxy resin including a total of 3 to 7 naphthalene units in the core exhibits the most preferable properties in terms of intermolecular attraction between adjacent epoxy main chains, packaging properties of the main chain of a resin, thermal expansion properties, and processability when a composition is prepared.

That is, the naphthalene-based epoxy resin according to the embodiments of the present invention includes three or more naphthalene-based core units, wherein the naphthalene-based unit consists of two different naphthalene-based units.

In the naphthalene-based epoxy resin, the naphthalene-based unit may consist of two different naphthalene-based structures. As used herein the term “two different naphthalene-based units” refers not only to naphthalene-based units which are different in terms of the structure of the naphthalene part, but also to naphthalene-based units which are different in terms of the binding position of the naphthalene part. For example, it is to be understood that naphthalenes, which are bound to the 1,6-carbon position and the 2,7-carbon position, are “different naphthalenes”.

As a preferred embodiment of the present invention, an example of a naphthalene-based epoxy resin which includes three naphthalene-based core units wherein the three naphthalene-based core units consist of two different naphthalene-based units (in Formula 1, A and E are core structure having identical naphthalene unit and D is a naphthalene unit which is different from the naphthalene units of A and E, and n is 0) is shown in the following Formula 2. The naphthalene-based epoxy resin in the following Formula 2 is provided for illustrative purposes only to assist in a further understanding of the present invention and is not intended to limit the scope of the present invention.

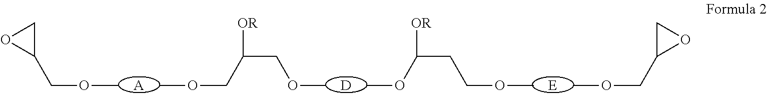

where R may be selected from the group consisting of hydrogen, an epoxy group, a vinyl group, an allyl group, a carboxyl group, an acid anhydride group,

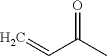

(the terminals thereof being connected), and

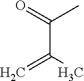

(the terminals thereof being connected). More specifically, it is not limited thereto, but D may be bound to the 1,6-carbon position, and the other part of A and E may be bound to the 2,7-carbon position.

In the naphthalene-based epoxy resin according to the present invention, the naphthalene-based unit may be selected from the group consisting of the Formula (1-5) and (1-6).

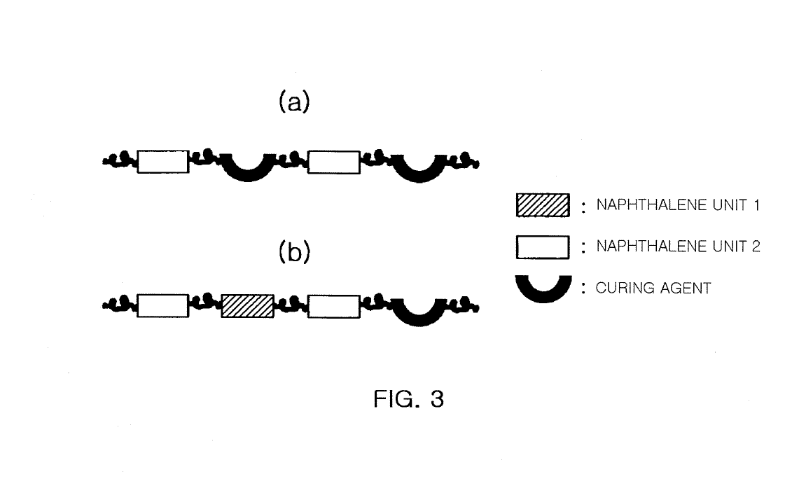

Hereinafter, a concept that the thermal expansion properties and processability of a naphthalene-based epoxy resin according to a preferred embodiment of the present invention are improved as the temperature increases will be described in more detail with reference to accompanying drawings. The concept is shown in the following FIG. 3. FIG. 3(a) shows a schematic view of the main chain of a naphthalene-based epoxy resin formed by a reaction of a naphthalene-based epoxy resin including one naphthalene-based core unit with a curing agent. FIG. 3(b) shows a schematic view of the main chain of a naphthalene-based epoxy resin according to an embodiment of the present invention, which is formed by a reaction of a naphthalene-based epoxy resin including two different naphthalene-based units and a total of three naphthalene-based core units with a curing agent.

When the network structure of an epoxy cured product is formed by a reaction of a naphthalene-based epoxy resin including one naphthalene-based core unit in the related-art with a curing agent, a main chain, in which the epoxy resin and the curing agent are alternately connected with each other, is formed, as shown in FIG. 3(a). The intermolecular packing properties of the main chain of adjacent epoxy molecules are frequently interfered by the curing agent part in the main chain. Thus, the free volume of the network structure of an epoxy cured product is increased and consequently a high coefficient of thermal expansion is exhibited because the restriction of movement of the main chain is not efficient as the temperature rises.

However, as shown in FIG. 3(b), when an cured epoxy product as a network structure is formed by a reaction of a naphthalene-based epoxy resin including three or more naphthalene-based core units, according to the present invention, with a curing agent, the interference of packing properties of adjacent epoxy resin main chains by the curing agent is significantly reduced due to the long naphthalene part, and the packing efficiency between adjacent epoxy resin main chains is also increased by a flat naphthalene molecular structure. Thus, the intermolecular attraction between adjacent epoxy resin main chains is increased, the free volume between epoxy resin main chains is decreased, the mobility of the resin main chain is inhibited as the temperature rises, and thus improved thermal expansion properties, that is, a low Coefficient of Thermal Expansion (CTE), improved dimensional stability and processability, are exhibited.

If the three or more naphthalene-based core units are same naphthalene-based units, the intermolecular attraction between epoxy resin main chains is increased too much due to high regularity (crystallinity) of the naphthalene-based units, and thus, a deteriorated processability is shown. That is, a epoxy composite may not be properly dissolved in solvents due to very low solubility of the resin therein, or the composite does not melt at the process temperature and thus, it may be very difficult to prepare a sample.

However, three or more naphthalene-based core units in a naphthalene-based epoxy resin according to an embodiment of the present invention consist of two different naphthalene-based units, and thus high crystallinity (regularity) of a naphthalene-based core structure is decreased due to structural differences (asymmetricity). Accordingly, intermolecular attraction between epoxy resin main chains is somewhat reduced, and thus, the processability of the naphthalene-based epoxy resin is improved. That is, the solubility thereof is enhanced, while the melting temperature thereof is decreased.

The naphthalene-based epoxy resin according to the present invention may be prepared by co-polymerizing two different naphthalene-based units. Specifically, the epoxy resin may be prepared by co-polymerizing a diepoxy naphthalene-based compound with a dihydroxy naphthalene-based compound. More specifically, a new naphthalene-based epoxy resin according to the present invention may be synthesized by dissolving a diepoxy naphthalene-based compound and a dihydroxy naphthalene-based compound in a solvent and followed by reaction. At this time, a base catalyst and/or a phase transfer catalyst may be used if necessary.

The diepoxy naphthalene-based compound and the dihydroxy naphthalene-based compound which are typically known in the art may be used and are not limited thereto. However, compounds in the following Formulas (3-1) and/or (3-2) may be used as the diepoxy naphthalene-based compound and compounds in the following Formulas (4-1) and/or (4-2) may be used as the dihydroxy naphthalene-based compound. These are provided for illustrative purposes only so as to assist in a further understanding of the present invention and are not intended to limit the scope of the present invention,

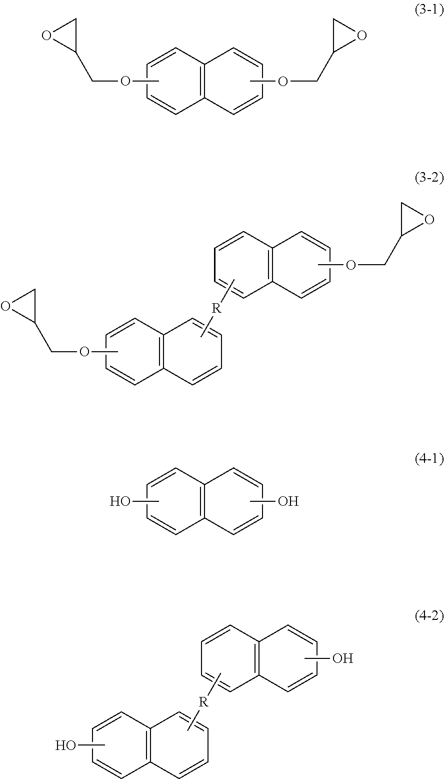

(where R in Formulas 3-2 and 4-2 may be a simple bond or a C1 to C5 alkanediyl group, and preferably may be a C1 to C3 alkanediyl group.)

In Formulas 3-1, 3-2, 4-1, and 4-2, a binding site of the epoxy group or the hydroxyl group to the naphthalene ring is not specified, but includes all the cases in which two epoxy or hydroxyl groups are substituted for any other two different carbons in the naphthalene ring. Although the binding sites are not limited thereto, it is to be understood that they include all cases in which the epoxy group or the hydroxyl group is each substituted for 1,2-, 1,3-, 1,4-, 1,5-, 1,6-, 1,7-, 2,3-, 2,6-, and 2,7-carbon positions. In addition, it is to be understood that the sites include all cases in which the sites are linked to any parts of two naphthalenes, such as 2,6-binaphthalenyl-7,7′-diol and 1,1-binaphthalenyl-2,2′-diol in Formula 4-2. This also applies to the case in Formula 3-2.

The diepoxy naphthalene-based compound is used in excess, and specifically, the dihydroxyl naphthalene-based compound and the diepoxy naphthalene-based compound may be used at a molar ratio of 1:10 to 1:2 ([dihydroxyl naphthalene-based compound]/[diepoxy naphthalene-based compound]), and more preferably a molar ration of 1:6 to 1:3. This is because it is difficult to synthesize an epoxy having epoxy functional groups at both terminals thereof when the molar ratio of [dihydroxyl naphthalene-based compound]/[diepoxy naphthalene-based compound] is more than 1/2 and difficult to control the molecular weight of the epoxy resin when the ratio is less than 1/10.

The reaction temperature and reaction time largely depend on the structures of a diepoxy naphthalene-based compound and a dihydroxyl naphthalene-based compound to be used, and thus may vary according to the diepoxy naphthalene-based compound and the dihydroxyl naphthalene-based compound to be used and are not limited thereto. However, the naphthalene-based epoxy resin may be obtained by a reaction, for example, at 0 to 150° C. for 5 minutes to 24 hours.

Any organic solvent may be used as long as it may effectively dissolve reactants, not affect the reaction adversely, and may be easily removed after the reaction is completed. It is not particularly limited thereto, but, for example, acetonitrile, tetrahydrofuran (THF), methyl ethyl ketone (MEK), dimethyl founamide (DMF), methylene chloride, or the like may be used.

Furthermore, during the polymerization when a base catalyst and/or a liquid-liquid phase transfer catalyst are used, the base catalyst may include, but is not limited to, for example, KOH, NaOH, K2CO3, KHCO3, NaH, triethyl amine, and diisopropyl ethyl amine. The phase transfer catalyst may include, but is not limited to, for example, triethyl benzyl ammonium chloride and tetramethyl ammonium chloride.

According to another embodiment of the present invention, epoxy resin in which the core structures of A, C, and E are identical to each other, those of B and D are identical to each other and one core structures between the core structures of A, C, and E and those of B and D is a naphthalene-based unit and the other is a cardo-based unit in formula 1, is provided (hereinafter, referred to as ‘cardo-based epoxy resins’). In this case, the side functional group R may be selected from the group consisting of hydrogen, an epoxy group, a vinyl group, an allyl group, a carboxyl group, an acid anhydride group,

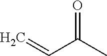

(the terminals thereof being connected), and

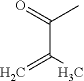

(the terminals thereof being connected).

In addition, n in the Formula 1 may be an integer of 0 to 100, preferably 0 to 20, more preferably 0 to 10, further preferably 0 to 5, still further preferably 0 to 2, and most preferably 0. When the number of repeating units is more than 100, crosslinking density is decreased due to an increase in molecular weight and it is difficult to process the epoxy material because the viscosity of the resin is increased. Thus, considering the physical properties and processablity thereof, the number of repeating units is preferably 100 or less. A cardo-based epoxy resin including a total of 3 to 7 core units (including a naphthalene-based unit and a cardo unit) exhibits the most preferable properties in terms of intermolecular attraction between adjacent epoxy main chains, packaging property of the main chain of a resin, thermal expansion properties, and processability when a composition is formed.

The naphthalene-based unit may be selected from the naphthalene-based structures in the Formulas (1-5) and (1-6) and the cardo-based unit may be selected from the cardo-based structures in the Formulas (1-7) to (1-12).

Although the present invention is not limited to the following structures, examples of epoxy resins alternately including a naphthalene-based unit of 2,6-dihydroxy naphthalene among the naphthalene-based compounds and a cardo-based unit of 9,9-bis(4-hydroxyphenyl)fluorene, for example, in the main chain are shown in the following Formulas 5 and 6.

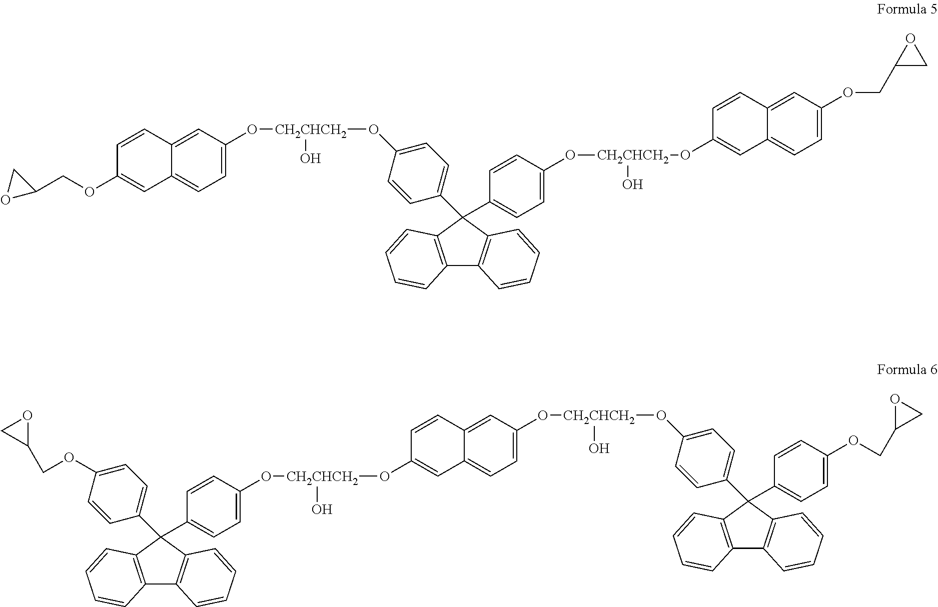

The epoxy resin including a naphthalene-based unit and a cardo-based unit in the main chain may be prepared, for example, by reacting a dihydroxy naphthalene compound with a diepoxy cardo compound or a diepoxy naphthalene compound with a dihydroxy cardo compound. Specifically, the epoxy resin including a naphthalene-based unit and a cardo-based unit in the main chain may be prepared by reacting a dihydroxy naphthalene compound with a diepoxy cardo compound or a diepoxy naphthalene compound with a dihydroxy cardo compound in a solvent. At this time, a base catalyst or/and a phase transfer catalyst may be used if necessary.

Although the present invention is not limited to the following structures, examples of the dihydroxy naphthalene compound and the dihydroxy cardo compound are shown in the following Formulas 7 and 8. The diepoxy naphthalene compound and the diepoxy cardo compound have glycidyl ether group (that is, an epoxy group) instead of a hydroxyl group in their chemical structures in the following Formulas 7 and 8. For example, the dihydroxy naphthalene compound or the dihydroxy cardo compound may be used by subjecting a hydroxyl group to an epoxidation reaction.

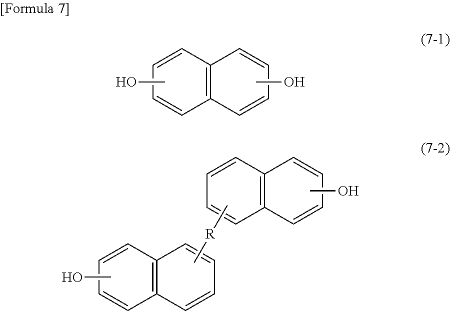

(Where R in Formula 7-2 may be a simple bond or a C1 to C5 alkanediyl group, and preferably may be a C1 to C3 alkanediyl group.)

A linking site of a hydroxyl group in the Formulas (7-1) and (7-2) and a bonding site between naphthalene rings in Formula (7-2) are not specified, meaning that they may be linked and bound, even to any carbon position in the naphthalene ring. Although the linking and binding sites are not limited thereto, it is to be understood that they include all cases in which the sites are bound to 1,2-, 1,3-, 1,4-, 1,5-, 1,6-, 1,7-, 2,3-, 2,6-, and 2,7-carbon positions in Formulas 7-1. In addition, it is to be understood that the sites include all cases in which the sites are linked to any parts of two naphthalenes, such as 2,6-binaphthalenyl-7,7′-diol and 1,1-binaphthalenyl-2,2′-diol in Formula 7-2.

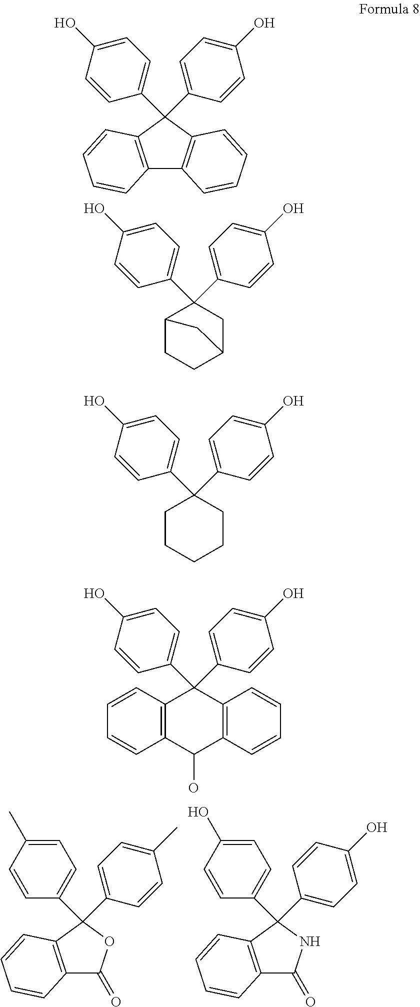

Although the present invention is not limited to the following structures, for example, the diepoxy naphthalene-based compound is used in excess when the cardo-based epoxy resin in Formula 5 is synthesized, and specifically, a dihydroxy cardo-based compound and a diepoxy naphthalene-based compound may be used at a molar ratio of 1:10 to 1:2 ([dihydroxy cardo-based compound]/[diepoxy naphthalene-based compound]), and more preferably a molar ratio of 1:6 to 1:3. This is because it is difficult to synthesize an epoxy having epoxy functional groups at both terminals thereof when the molar ratio of [dihydroxy cardo-based compound]/[diepoxy naphthalene-based compound] is more than 1/2 and difficult to control the molecular weight of the epoxy resin when the ratio is less than 1/10.

In addition, for example, the diepoxy cardo-based compound is used in excess when the cardo-based epoxy resin in Formula 6 is synthesized, and specifically, a dihydroxyl naphthalene-based compound and a diepoxy cardo-based compound may be used at a molar ratio of 1:10 to 1:2 [dihydroxyl naphthalene-based compound]/[diepoxy cardo-based compound], and more preferably a molar ratio of 1:6 to 1:3. This is because it is difficult to synthesize an epoxy having epoxy functional groups at both terminals thereof when the molar ratio of [dihydroxyl naphthalene-based compound]/[diepoxy naphthalene-based compound] is more than 1/2 and difficult to control the molecular weight of the epoxy resin when the ratio is less than 1/10. The reaction temperature and reaction time largely depend on the structures of a diepoxy naphthalene-based compound and a dihydroxy cardo-based compound or a diepoxy cardo-based compound and a dihydroxyl naphthalene-based compound to be used, and thus may vary according to the compounds to be used. Specifically, a naphthalene-cardo based copolymerization epoxy resin according to the present invention may be obtained by reaction at 0 to 150° C. for 5 min to 24 hours.

Any organic solvent may be used as long as it may effectively dissolve reactants, not affect the reaction adversely, and may be easily removed after the reaction is completed. It is not particularly limited thereto, but, for example, acetonitrile, tetra hydro furan (THF), methyl ethyl ketone (MEK), dimethyl formamide (DMF), methylene chloride, or the like may be used.

Furthermore, during the polymerization when a base catalyst and/or a liquid-liquid phase transfer catalyst is used. The base catalyst may include, but are not limited to, for example, KOH, NaOH, K2CO3, KHCO3, NaH, triethyl amine, or diisopropyl ethyl amine. The phase transfer catalyst may include, but are not limited to, for example, triethyl benzyl ammonium chloride and tetramethyl ammonium chloride.

The cardo compound refers to a compound having a cyclic side group in the molecular main chain. The cardo compound provides a severe rotational hindrance to the main chain due to structural characteristics that a bulky lateral group is present in the polymer main chain, thereby having very high thermal resistance (high glass transition temperature) and excellent processability.

An epoxy resin including a naphthalene-based unit and a cardo-based unit in the main chain exhibits improved thermal resistance by a robust cardo-based unit included in the main chain. That is, the glass transition temperature is increased and thermal expansion properties are improved. In addition, a cardo-based unit having an out-of-plane structure is introduced into the main chain to reduce the crystallinity of the naphthalene, and thus the processability of the material (for example, solubility) is improved. Furthermore, a new epoxy resin including a naphthalene-based unit and a cardo-based unit in the main chain has an improved thermal resistance due to improvement in rigidity of the main chain, and thus it is not necessary to increase the concentration of the epoxy functional group (decrease in epoxy equivalent) to increase the crosslinking density (degree of curing) of a cured product in order to improve the thermal resistance of the epoxy resin as in the related art. Thus, an increase in an OH group and an increase in the free volume, which may be accompanied by an increase in linking density, can be moderately controlled, and thus an increase in water absorption and dielectric constant with the crosslinking density, which are a side adverse effect, may be properly controlled.

In addition, when an epoxy resin which includes a naphthalene-based unit and a cardo-based unit in the main chain and has a side functional group R being at least one specific side group selected from the group consisting of hydrogen, an epoxy group, a vinyl group, an allyl group, a carboxylic group, an acid anhydride group,

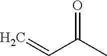

(the terminals thereof are connected), and

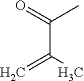

(the terminals thereof are connected) forms composite with a filler, the filler is strongly bound to the epoxy resin and filled between the epoxy resins by a chemical bond of the specific side group of the epoxy resin with a functional group of the filler, and thus a composite with improved thermal resistance properties may be prepared.

A composition including a new epoxy resin which has a naphthalene-based unit and a cardo-based unit in the main chain has improved thermal resistance properties at high temperatures when a cured product is prepared, that is, improved glass transition temperature and mechanical strength at high temperatures due to a high thermal resistance of the new epoxy resin itself. Furthermore, a composition including an epoxy resin which has a naphthalene-based unit and a cardo-based unit in the main chain, and has a specific side functional group has excellent thermal resistance of the epoxy resin itself due to a new core structure of the epoxy resin when a cured product is prepared. In addition, when the filler composite is prepared by using new epoxy resin, further improved thermal resistance is exhibited and thermal expansion properties are also significantly improved, probably due to a chemical bond between the epoxy resin and the filler through the specific side functional group of the epoxy,

2. An epoxy resin composition having improved thermal expansion properties and processability

In another embodiment of the present invention, there is provided an epoxy resin composition including the epoxy resin according to an embodiment of the present invention, a curing agent, and a filler. The description on the epoxy resin as described above applies to the epoxy resin in the epoxy resin composition provided in the embodiment, and thus a further description on this will be omitted here.

As used herein, the term “epoxy resin composition” is used as having a comprehensive meaning to include all the compositions before and/or after a curing reaction, including not only an epoxy resin according to the present invention, a curing agent, and a filler (inorganic particles (inorganic filler) and glass fibers), but also any optional catalyst, other additives, or the like.

As the curing agent, any curing agent which is typically known as a curing agent for an epoxy resin may be used, and may include, but is not limited to, for example, amine-based curing agents, phenol-based curing agents, anhydrides-based curing agents, or the like.

More specifically, the amine-based curing agent may include, but are not limited to, aliphatic amines, cycloaliphatic amines, aromatic amine, other amines, and modified polyamines, and amine compounds including two or more primary amine groups may be also used. Specific examples of the amine curing agent may include one or more aromatic amines selected from the group consisting of 4.4′-dimethyl aniline (diamino diphenyl methane) (DAM or DDM), diamino diphenyl sulfone (DDS), and m-phenylene diamine, at least one aliphatic amine selected from the group consisting of diethylene triamine (DETA), diethylene tetramine, triethylene tetramine (TETA), m-xylene diamine (MXDA), methane diamine (MDA), N,N′-diethylenediamine (N,N′-DEDA), tetraethylenepentamine (TEPA), and hexamethylenediamine, one or more cycloaliphatic amines selected from the group consisting of isophorone diamine (IPDI), N-aminoethyl piperazine (AEP), bis(4-amino 3-methylcyclohexyl)methane, and Larominc 260, other amines such as dicyandiamide (DICY), and modified amines such as polyamides, epoxides, or the like.

Examples of the phenol-based curing agent may include, but are not limited to, a phenol novolac resin, a trifunctional phenol novolac resin, cresol novolac, a bisphenol A novolac resin, a phenol p-xylene resin, a phenol 4,4′-dimethylbiphenylene resin, a phenol dicyclopentadiene resin, dicyclopentadiene-phenol novolac (DCPD-phenol), xylok(p-xylene modification), a biphenyl-based phenol resin, a naphthalene-based phenol resin, or the like.

Examples of the anhydride based curing agent may include, but are not limited to, aliphatic anhydride such as dodecenyl succinic anhydride (DDSA), poly azelaic poly anhydride, or the like, cycloaliphatic anhydride such as hexahydrophthalic anhydride (HHPA), methyl tetrahydrophthalic anhydride (MeTHPA), methylnadic anhydride (MNA), or the like, aromatic anhydrous oxides such as trimellitic anhydride (TMA), pyromellitic acid dianhydride (PMDA), benzophenonetetracarboxylic dianhydride (BTDA), or the like, halogen-based anhydrous compounds such as tetrabromophthalic anhydride (TBPA), chlorendic anhydride (HET), or the like.

In general, the degree of cure of an epoxy resin cured product may be controlled by a curing agent. The content of a curing agent may be controlled based on the concentration of epoxy groups in the epoxy resin according to the range of a desired degree of cure. In an equivalent reaction of the amine curing agent with the epoxy group, one amine group per two epoxy groups is a quantitative concentration, and the amine curing agent may be used at a concentration ratio, which is a molar ratio of 2/1 ([epoxy group]/amine group [NH2]) in an equivalent reaction. Thus, in the present invention, the amine curing agent may be used in a molar ratio of 0.5 to 3.0 ([epoxy group]/amine group [NH2]) based on the epoxy group in the epoxy resin, and preferably a molar ration of 1.0 to 2.5. The molar concentration of the amine group at the molar ratio of [epoxy group]/amine group does not include an amino group included in a glass fiber to be described below. An epoxy side functional group in the epoxy resin and an epoxy reactive functional group of the filler are included in the molar concentration of the epoxy group.

Although the mixing amount of the curing agent has been described with reference to the amine-based curing agent, the phenol-based curing agent, the anhydride-based curing agent, and any curing agent which may be used in curing an epoxy resin which has not specifically described in the present specification may be appropriately mixed and used in a stoichiometric amount considering a chemical reaction of the epoxy functional group with the reactive functional group in the curing agent based on the concentration of total epoxy groups in the epoxy resin composition based on the range of a desired degree of cure, and the amount is generally known in the related art.

Inorganic particles and/or fibers may be used as a filler constituting a composition according to the present invention.

Any inorganic particles and fibers may be used, as long as they are generally known in the related art that can be used epoxy resin composition. As the inorganic particles, SiO2, ZrO2, TiO2, Al2O3, or a mixed metal oxide thereof (for example, silica-Zr oxide) and silsesquioxane, but not limited thereto, may be used alone or in combination of two or more. The silsesquioxane has cage, T-10, and ladder types, all of which may be used in the present invention.

As the fibers, any typical fiber, which is used in order to improve physical properties of organic resin cured product, specifically an epoxy resin cured product to be used as a substrate, or the like, may be used. Specifically, glass fibers, organic fibers, or a mixture thereof may be used. In addition, as used herein, the term ‘glass fibers’ includes not only glass fibers, but also glass fiber fabrics, glass fiber non-woven fabrics, or the like. The glass fibers may include, but are not limited to, glass fibers of E, T(S), NE, E, D, quartz, or the like. The organic fiber is not particularly limited, but liquid crystal polyester fibers, polyethylene terephthalate fibers, wholly aromatic fibers, polyoxybenzazole fibers, or the like may be used alone or in combination of two or more.

The inorganic particles and fiber filler may have at least one functional group (hereinafter, it is referred to as ‘reactive functional group’) selected from the group consisting of but are not limited to, an epoxy group, an amino group, a (meth)acrylate group, a C2 to C6 alkylene group, an allyl group, a thiol group, and a maleimide group on the surface thereof. The reactive functional group on the filler surface is chemically reacted with and bound to a specific side functional group in the epoxy resin.

Examples of a filler which may be used for an epoxy resin composition according to an embodiment of the present invention may include, but are not limited to, those shown in the following Formula 9.

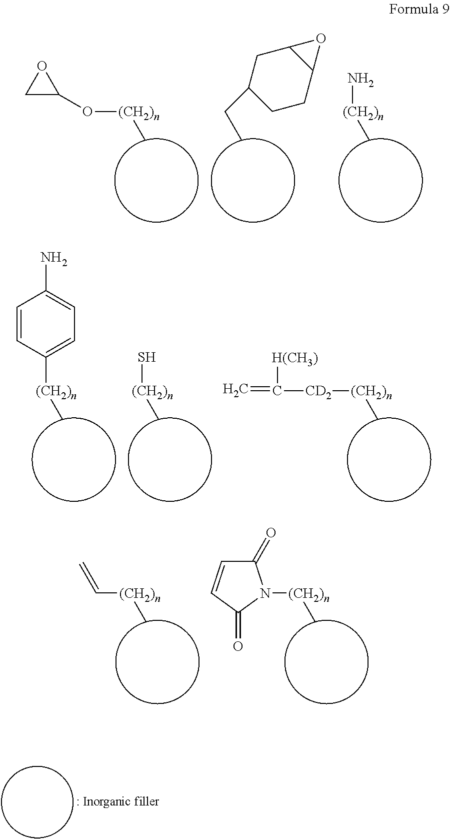

(where n is an integer of 0 to 10)

Furthermore, the inorganic filler and fiber filler may additionally include a functional group (hereinafter, it is referred to as ‘a compatible functional group’ for convenience) of an aliphatic or aromatic molecule in addition to the reactive functional group. The compatibility of the epoxy resin with the filler is improved by the compatible functional group. The compatible functional group may include, but is not limited to, at least one selected from the group consisting of, for example, a C1 to C10 alkyl, a C2 to C10 alkylene, a C3 to C8 aryl or arylene, a C1 to C10 alkoxy, a C3 to C8 aromatic alkyl, a C3 to C8 aromatic alkoxy, a C3 to C7 hetero aromatic alkoxy (the hetero element is at least one selected from the group consisting of O, N, S, and P), a C3 to C7 hetero aromatic alkyl (the hetero element is at least one selected from the group consisting of O, N, S, and P), a (meth)acrylate group, a vinyl group, an allyl group, a thiol group, and a maleimide group.

Considering the reactivity and compatibility (miscibility) of the inorganic particles and fiber filler with the epoxy resin, inorganic particles and fiber filler which additionally include at least one of the compatible functional groups may be also used. Furthermore, the filler may include those including the reactive functional group and the compatible functional group. Examples of the filler including the reactive functional group and the compatible functional group include, but are not limited to, inorganic particle fillers in the following Formula 10. More specifically, for example, a filler having 50% by mole of a benzene group and 50% by mole of an epoxy functional group, but not limited thereto, may be used.

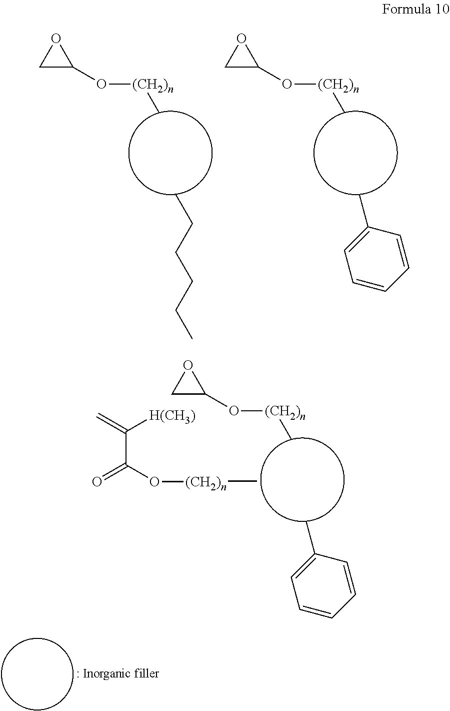

(where n is an integer of 0 to 10)

Considering the use of a composite, specifically, the dispersibility of inorganic particles, or the like, inorganic particles having a particle size of 0.5 nm to several tens of μm, but not limited thereto, may be used. The inorganic particles should be well dispersed in an epoxy resin, and thus the choice of the inorganic particles size is important, since the dispersibility strongly depends on particle size. In contrast, fibers usually form composite with an epoxy resin in a manner in which the fiber was dipped in the resin, and thus, the size of the fiber is not particularly limited, and any fiber typically used in the art may be used.

A new epoxy resin according to an aspect of the present invention and a filler having an amino group on the surface thereof, but not limited thereto, are reacted with each other as in the following Reaction Formula 1, and thus inorganic particles may be chemically bound to a modified epoxy resin.

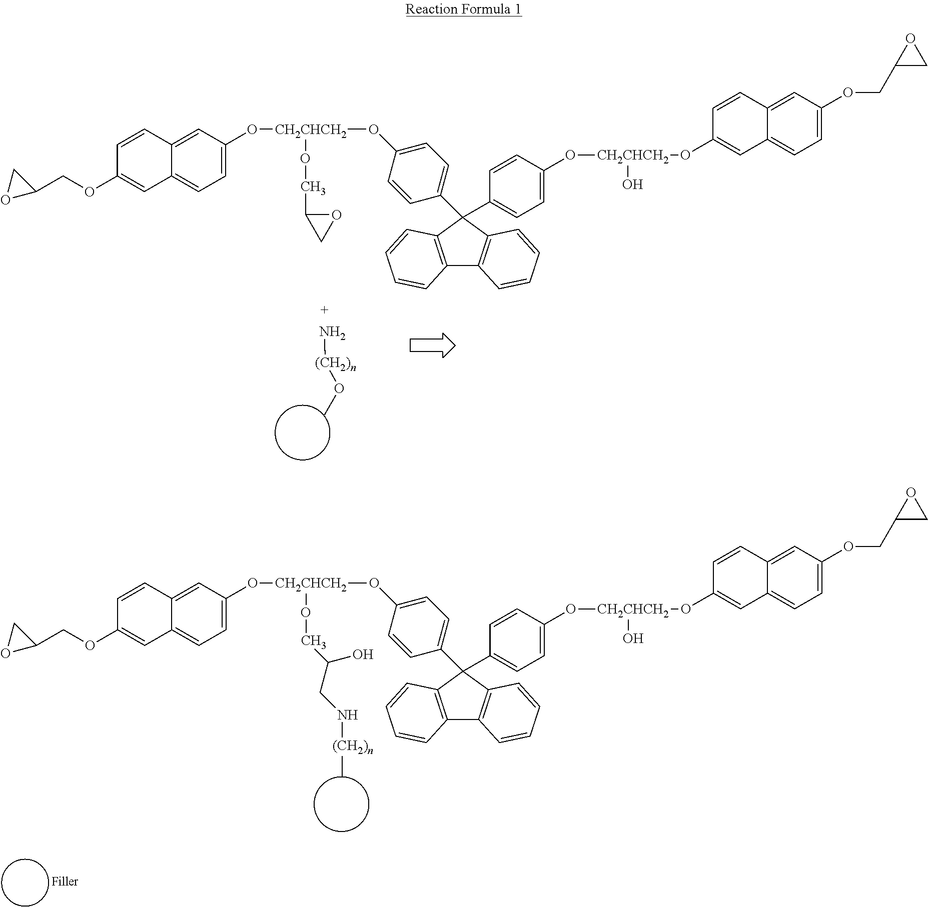

When inorganic particles are used as a filler in a composition according to the present invention, the inorganic particles may be mixed in an amount of 5 to 1000 phr (parts per hundred, parts by weight per 100 parts by weight) based on the epoxy resin. When the mixing amount of the inorganic particles is less than 5 phr, an increase in the glass transition temperature of a composition and an improvement of the thermal resistance thereof are not sufficient. When the amount is more than 1000 phr, the viscosity of a composition is increased and thus the processability is greatly decreased.

When a fiber is used as a filler in a composition according to the present invention, the fiber may be present in an amount of 10 to 90% by weight based on the total weight of the composition. When the fiber is present in an amount of less than 10% by weight, an improvement of the thermal resistance of the composition may not be sufficient. When the amount is more than 90% by weight, the amount of an epoxy as a binder is relatively small and thus it is difficult to prepare the glass fiber composite. If the composition includes resin, inorganic particles, a curing agent, and an optional catalyst, the total weight of the composition refers to a total weight of the composition including the all amounts of them.

A filler used in a composition according to the present invention, specifically, inorganic particles and fibers, and a preparation method thereof are generally known in the art, and the surface treatment of the inorganic particles and fibers which is prepared by any known preparation method may be used in the composition of the present invention. For example, 0.2 to 1.0% by weight of γ-aminopropyltriethoxysilane as a silane coupling agent may be added to a mixed solution of 95% by weight of ethanol and 5% by weight of distilled water, and a glass fiber may be impregnated with the resulting solution for 30 min, removed from the solution, left to react at 110° C. in an oven for 30 min, and completely dried at room temperature overnight to obtain glass fiber having the amino functional group.

The epoxy resin composition according to the present invention may further include a catalyst in order to facilitate the curing reaction of the epoxy resin and the curing agent. As the catalyst, any catalyst which is known to be generally used in an epoxy resin composite in the art may be used, and examples of the catalyst may include, but are not limited to, tertiary amines such as dimethyl benzyl amine (BDMA), 2,4,6-tris(dimethylaminomethyl)phenol, DMP-30, or the like, imidazoles such as 2-methylimidazole (2MZ), 2-ethyl-4-methyl-imidazole (2E4M), 2-heptadecylimidazole (2HDI), or the like, and Lewis acids such as BF3-monoethyl amine (BF3-MEA), or the like.

Other additives such as a viscosity controlling agent, a diluent, or the like, which are generally mixed in order to control the physical properties of other curing agents, may be also mixed if necessary. The mixing ratios of additional other additives such as these catalysts, viscosity controlling agents, diluents, or the like, are not particularly limited, and an amount appropriate for improving physical properties of a composite in a range, which is known as an amount which may be typically mixed in the art, may be used.

During a curing reaction of the composition, two chemical reactions may be simultaneously performed. That is, they are (1), a curing reaction of an epoxy functional group at the terminal of an epoxy resin with a curing agent and (2), a reaction of a specific side functional group of the epoxy resin with a reactive functional group on the surface of a filler. An epoxy polymer network is produced by the reaction of an epoxy resin and a curing agent and simultaneously the reaction of the epoxy resin and a filler allows the filler to be part of epoxy polymer network. Thus, the thermal resistance and glass transition behavior of the cured product are significantly improved, compared to cured products including the related art epoxy resin without modified functional groups and fillers. Furthermore, the compatible functional group also participates in the curing reaction and subsequently forms the extra crosslinking site.

Hereinafter, a specific curing reaction of a modified epoxy resin and a filler will be described.

The curing reaction of the epoxy resin composition according to an embodiment of the present invention may employ any reaction conditions which are typically known. The curing reaction of the epoxy resin and a curing agent may be performed under any reaction conditions which are typically known as a curing reaction of an epoxy resin, and the addition of a filler will not change the curing reaction conditions.

The curing reaction conditions may be changed according to the structure of an epoxy to be used, the type of a curing agent, the use of a catalyst, or the like, and curing reaction conditions may be appropriately selected by those skilled in the art according to the ingredients of the epoxy resin composition.

As described above, the curing reaction of the epoxy resin and the curing is a typical reaction. Although it is not limited thereto, diglycidyl ether of bisphenol A (DGEBA) epoxy resin and 4,4′-dimethylaniline curing agent may be reacted at 150° C. for 2 hours and followed by a further reaction at 170 to 200° C. for 3 hours. When curing is performed by using a phenol-based curing agent such as phenol novolac resin as a curing agent, 1 phr of a triphenylphosphine catalyst was additionally used, curing is performed at 150° C. for 2 hours, and then the system was heated at 190° C. for 3 hours to react the epoxy group with the curing agent. The reaction is provided for a better understanding of the present invention, and the reaction is not limited thereto.

The reaction of a specific side functional group of an epoxy resin according to the present invention with a reactive functional group of a filler may be changed according to the kind of a functional group to participate in the reaction. For example, a side functional group such as an epoxy group, a carboxyl acid group, and an acid anhydride group in an epoxy resin as in Reaction Formula 1, may be chemically reacted with and bound to an amino group or an epoxy group in a filler. As in Reaction Formula 2, a (meth)acrylate group, a vinyl group, and/or an allyl side functional group in a resin having the (meth)acrylate group, the vinyl group, and/or the allyl group may be chemically reacted with and bound to at least one binding functional group selected from the group consisting of a (meth)acrylate group, a vinyl group, an allyl group, an imidazole group, and a thiol group in a filler.

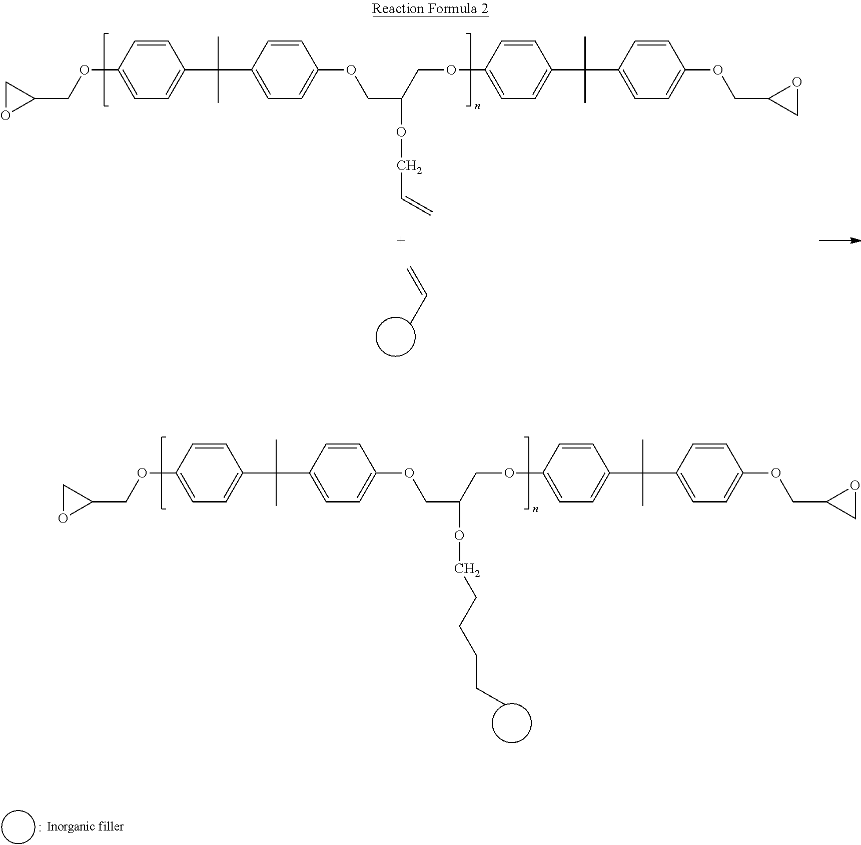

(Where n is 2.)

As described above, when a composition according an embodiment of the present invention is cured, a specific side functional group of an epoxy resin is chemically bound to a reactive functional group of a filler or the epoxy resin is strongly bound to and incorporated into the filler by a specific unit of the epoxy resin core, and the mobility of the polymer main chain is efficiently limited by the filler. Thus, a thermosetting polymer composition according to the present invention has an increased glass transition temperature which exhibits a thermal transition with increasing temperature increases. Moreover, the thermal transition behavior thereof is inhibited. Accordingly, the thermosetting polymer composition according to the present invention exhibits improved thermal resistance.

In addition, an epoxy resin having a specific side functional group in the epoxy resin composition is advantageous in that the concentration of a hydroxyl group (—OH group) in an epoxy resin is decreased and thus the dielectric constant and water absorption of a composite are decreased. Physical properties of a cured product, such as thermal resistance and modulus, are also improved further by a chemical bonding of filler to the main chain of the epoxy resin.

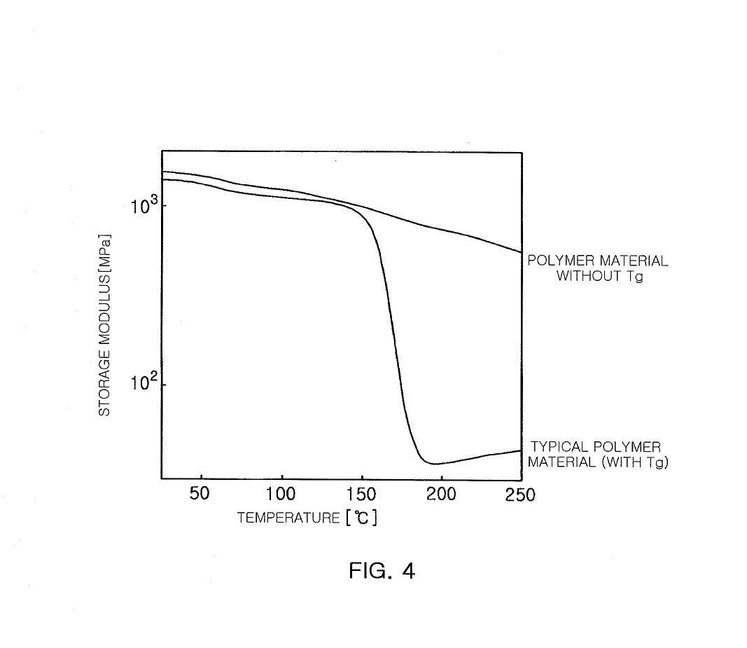

Furthermore, as shown in FIG. 4, the storage modulus of a polymer system is typically sharply decreased at a temperature of the glass transition temperature, indicating that the strength of the polymer system is decreased. However, the glass transition behavior of a cured product according to the present invention is inhibited, and thus a drastic decrease in storage modulus, that is, a reduction in strength is not observed even at intervals of the glass transition temperature or higher. In addition, a typical thermosetting polymer composition has a significantly decreased strength at a temperature higher than the glass transition temperature. However, a thermosetting polymer composition according to the present invention has a glass transition temperature higher than those of the related art compositions, and thus, the composition has excellent strength in a temperature range at which a composition is prepared and a process using the same is performed.

In a composition according to an embodiment of the present invention, the epoxy resin is bound to a filler by chemical reaction of a specific side functional group of the epoxy resin with a reactive functional group in the filler. Thus, the epoxy resin and filler form composite by a strong chemical bond between the epoxy resin and the filler. Therefore, an epoxy resin composition according to the present invention not only has an increased glass transition temperature which shows changes in thermal expansion properties, but also exhibits improved thermal resistance because changes in thermal properties at a high temperature are inhibited.

Specifically, thermosetting polymer composition of this invention exhibits improved thermal expansion properties at a high temperature, that is, a low coefficient of thermal expansion is exhibited due to a higher glass transition temperature. Further, the glass transition behavior of thermosetting polymer compositions according to an embodiment of the present invention may be inhibited, decreased, or weakened, or not exhibited with increasing temperature and preferably, the glass transition behavior of thermosetting polymer compositions according to an embodiment of the present invention may be inhibited, decreased, or weakened, or not exhibited in a temperature range at which the epoxy is used.

In addition, a significant change in mechanical strength occurring at the glass transition temperature or higher is minimized and/or these changes in physical properties are not exhibited. Thus, the compositions according to an embodiment of the present invention exhibit the improved thermal expansion properties at a process temperature, being compared with those of the related art polymer compositions.

As used herein, the term “inhibition of glass transition behavior” is used to include all the states that the glass transition behavior of a polymer composite is inhibited, decreased, and weakened, and thus a phase transition from the glass phase to the rubber phase, and an increase in coefficient of thermal expansion, dimensional change, and strength change due to the phase transition are inhibited, decreased, and/or weakened, and preferably, the glass transition temperature properties may not be shown (without any phase transition temperature from the glass phase to the rubber phase).

However, the glass transition behavior is one of properties that are exhibited due to thermal transition of a polymer composition from the glass phase to the rubber phase as the temperature increases, and thus improved effects of the glass transition behavior of the polymer composition are exhibited when a composition is cured.

A composite provided according to an embodiment of the present invention is appropriate for use in the next generation semiconductor substrate, the next generation PCB, packaging, OTFT, the flexible display substrate, or the like.

While the present invention has been shown and described in connection with the exemplary embodiments, it will be apparent to those skilled in the art that modifications and variations can be made without departing from the spirit and scope of the invention as defined by the appended claims.

### MODE FOR INVENTION

Hereinafter, the present invention will be described in detail with reference to Examples.

### EXAMPLE 1

### Synthesis of Naphthalene-Based Epoxy Resin

34 g of naphthalene-epoxy monomer (diglycidyl ether of 2,7-dihydroxyl naphthalene) and 0.85 g of tri-ethyl benzyl ammonium chloride were put into a flask, and then air in the flask was evacuated to a vacuum. Next, 100 Ml of CH3CN was added to the flask and stirred for 5 min to obtain a homogeneous solution. Subsequently, a solution of 5 g of 1,6-dihydroxyl naphthalene in 100 Ml of CH3CN was slowly added dropwise to the homogeneous solution, and the mixture was left to react at 80° C. for 24 hours. Subsequently, the solvent was removed with an evaporator, and the residue was dissolved in 500 Ml of ethyl acetate and worked up with H2O. Subsequently, the organic layer was separated, and ethyl acetate was removed with an evaporator to obtain a naphthalene-based epoxy resin of the following Formula 11. The synthetic reaction formula of the thus-obtained naphthalene-based epoxy resin of the Formula 11 is shown in the following Reaction Formula 3. In addition, an NMR result of the compound of Formula 11 synthesized in the present Example is as follows.

1H NMR (400 MHz, CDCl3) δ 8.16 (d, J=9.2 Hz, 1H), 7.63 (d, J=8.8 Hz, 4H), 7.30 (d, J=3.2 Hz, 2H), 7.14-6.96 (m, 10H), 6.69 (t, J=4.0 Hz, 1H), 4.56-4.46 (m, 2H), 4.36-4.25 (m, 10H), 4.00-3.95 (m, 2H), 3.37 (s, 1H), 2.99-2.89 (m, 4H), 2.76-2.75 (m, 2H)

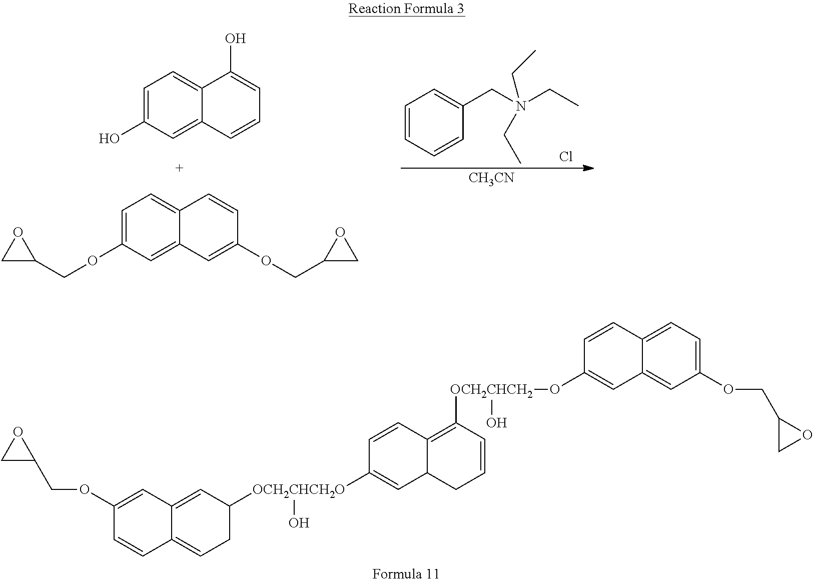

### EXAMPLE 2

### Preparation of Thermosetting Product Using Naphthalene-Based Epoxy Resin

1.95 g of the naphthalene-based epoxy resin prepared in Example 1 was added in 30 g of methylene chloride, and the resulting mixture was uniformly mixed using a mixer. 0.45 g of diaminodiphenylmethane (DDM) (Formula 12) was added to the mixture and mixed using a shaker to obtain a homogeneous solution. The solution prepared was placed into a vacuum oven preheated to 120° C., left for 5 min to remove the solvent, and then poured into a mold preheated to 120° C. Next, the product was left to react at 150° C. under nitrogen atmosphere for 2 hours and cured at 230° C. for further 2 hours by increasing the temperature of the oven to obtain a resin cured product.

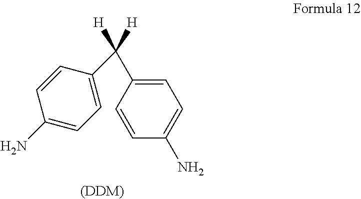

### COMPARATIVE EXAMPLE 1

### Preparation of Cured Product using DGEBA (DGEBA-DDM)

1 g of diglycidyl ether of bisphenol A (DGEBA, Mn: 377) was dissolved in 1.5 g of methylene chloride and 0.263 g of diaminodiphenylmethane (DDM) was added to the resulting solution, and the resulting mixture was mixed with a mini-shaker to obtain a homogeneous solution. The solution thus prepared was placed into a vacuum oven preheated to 120° C., left for 5 min to remove the solvent, and then poured into a mold preheated to 120° C. Subsequently, the product was cured at 120° C. for 2 hours, additionally cured at 150° C. for 2 hours and then at 200° C. for further 2 hours by increasing the temperature of the oven in a nitrogen purged state to prepare an epoxy resin cured product. The reaction formula of a curing reaction of DGEBA and DDM in Comparative Example 1 is shown in the following Reaction Formula 4.

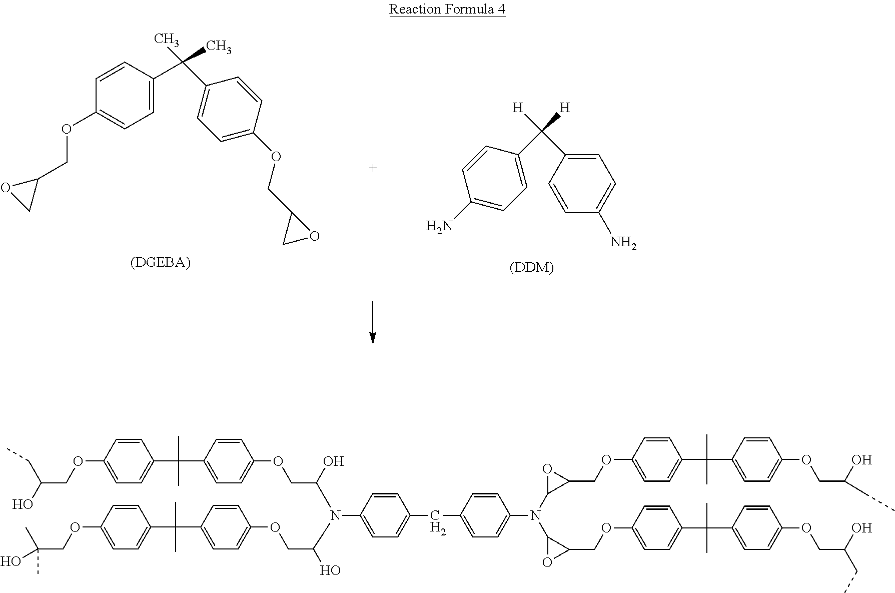

### Comparative Example 2

### Preparation of Cured Product using Naphthalene-Based Epoxy Resin

1 g of 1,6-naphthalene diepoxy was placed into a vacuum oven preheated to 120° C., melted, and then degassed. 0.364 g of diaminodiphenylmethane (DDM) was added thereto, the resulting mixture was melted at 120° C. in an oven, and the resulting solution was mixed for 1 min to obtain a homogeneous solution. The solution thus prepared was placed into a vacuum oven preheated to 120° C. to remove bubbles, and then poured into a mold preheated to 120° C. Subsequently, the product was cured at 120° C. for 2 hours, additionally cured at 150° C. for 2 hours and then at 230° C. for further 2 hours by increasing the temperature of the oven in a nitrogen purged state to prepare an epoxy resin cured product.

[Evaluation of Physical Properties 1]: Evaluation of Thermal Expansion Properties

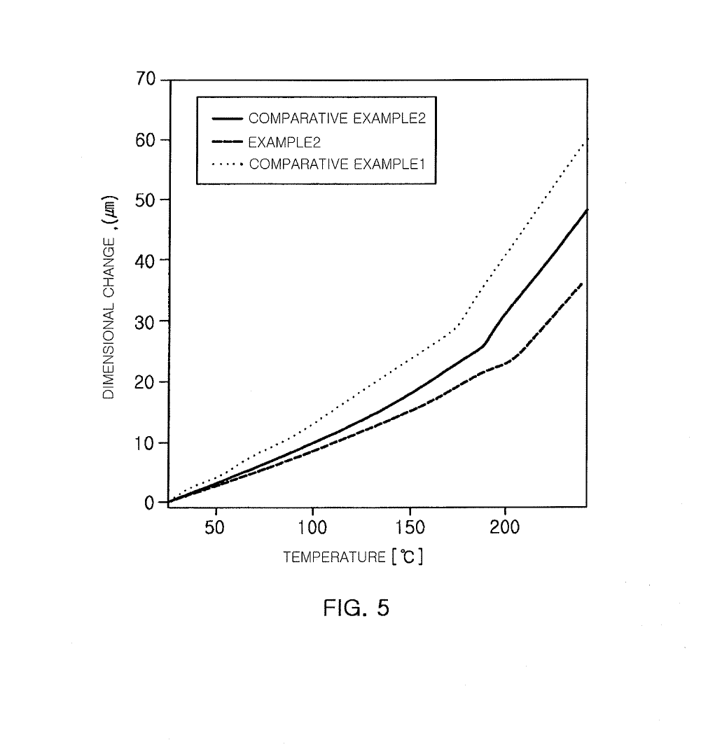

The dimensional changes of the resin cured products prepared in Examples and Comparative Examples according to the temperature were evaluated by using a thermo-mechanical analyzer (Expansion mode, Force 0.03 N) and shown in FIG. 5. A sample of the cured product was prepared to have a dimension of width x length x thickness of 5 mm×5 mm×3 mm.

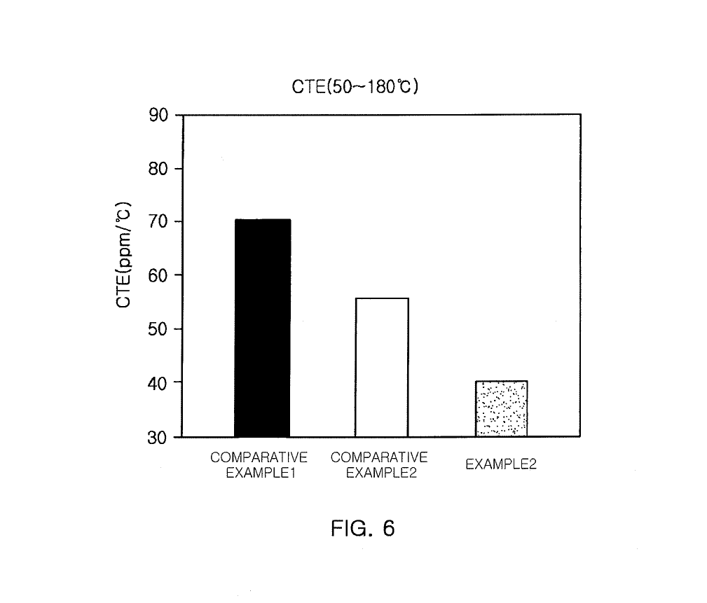

As shown in FIG. 5, in the cured product of Example 2, in which the naphthalene-based epoxy resin in the Example of the present invention was used, it was confirmed that rates of expansion of the cured product were decreased and thus the dimensional change of an epoxy resin composite was decreased as the temperature increases. In addition, as shown in FIG. 6, when a new naphthalene-based epoxy resin in Example 1 was used, the CTE (α1) value at a temperature below the glass transition temperature was 44 ppm/° C., which was decreased by about 43% compared to that of the epoxy cured product (DGEBA-DDM, 70 ppm/° C.) in Comparative Example 1 and decreased by about 30% compared to that of the naphthalene epoxy cured product (56 ppm/° C.) in Comparative Example 2.

### EXAMPLE 3

### Preparation of Epoxy Resin Having Acrylate Side Functional Group

10 g of a trimer epoxy resin in the following Formula 13 was added to 60 Ml of methylene chloride in a 250 Ml flask at room temperature, and the resulting solution was stirred. 9.88 Ml of diisopropyl ethylamine was added to the solution at 0° C., and immediately 4.6 Ml of acryloyl chloride was slowly added to the resulting mixture. The mixture was left to react at 0° C. for 2 hours, and then the organic layer was worked up with brine. The remaining water in the organic layer was removed with MgSO4, and then the resulting mixture was evaporated to remove the solvent and obtain an epoxy resin 14 having an acrylate group. The synthetic reaction formula of a new epoxy in Example 3 is shown in the following Reaction Formula 5.

1H NMR (400 MHz, CDCl3) δ 8.14 (d, J=8.8 Hz, 1H), 7.66 (d, J=8.8 Hz, 4H), 7.32 (d, J=3.2 Hz, 2H), 7.16-7.00 (m, 10H), 6.74 (dd, J=3.2 Hz, 1H), 6.50 (d, J=17.2 Hz, 2H), 6.20 (q, J=10.0 Hz, 2H), 5.89 (d, J=10.4 Hz, 2H), 5.81 (t, J=4.8 Hz, 1H), 5.70 (t, J=4.8 Hz, 1H), 4.47 (dd, J=4.4 Hz, 8H), 4.31-4.27 (m, 2H), 4.06-4.01 (m, 2H), 3.41 (s, 2H), 2.95-2.92 (m, 2H), 2.81-2.79 (m, 2H).

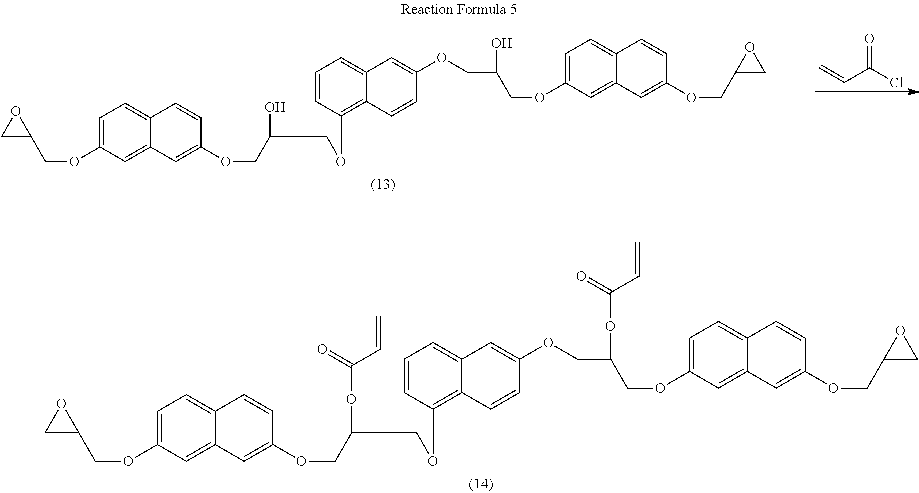

### Example 4

### Preparation of Epoxy Resin Having Epoxy Side Functional Group

0.85 g of NaH was put into a flask at room temperature to be dissolved in 20 Ml of DMF, and 5 g of a trimer epoxy resin in the following Formula 13, which was dissolved in 10 Ml of DMF at 0° C., was slowly added to the resulting solution. The solution was stirred at 0° C. for 10 min, 2.22 Ml of epichlorohydrin was slowly added to the solution, and then the resulting mixture was left to react at room temperature for 12 hours. After the reaction was completed, the mixture was quenched with saturated NH4Cl and worked up with brine. The organic layer was separated, the remaining water in the organic layer was removed with MgSO4, the resulting organic layer was filtered and evaporated, and then the solvent was removed to obtain an epoxy resin 15 having an epoxy side functional group. The synthetic reaction formula of a new epoxy according to the present Example is shown in the following Reaction Formula 6.

1H NMR (400 MHz, CDCl3) δ 8.17 (d, J=9.6 Hz, 1H), 7.66 (d, J=8.8 Hz, 4H), 7.34 (d, J=6.0 Hz, 2H), 7.17-7.01 (m, 10H), 6.75 (t, J=2.8 Hz, 1H), 4.38-4.28 (m, 12H), 4.14-4.01 (m, 4H), 3.80-3.72 (m, 2H), 3.41 (s, 2H), 3.24 (s, 2H), 2.94-2.92 (m, 2H), 2.83-2.79 (m, 4H), 2.69-2.68 (m, 2H).

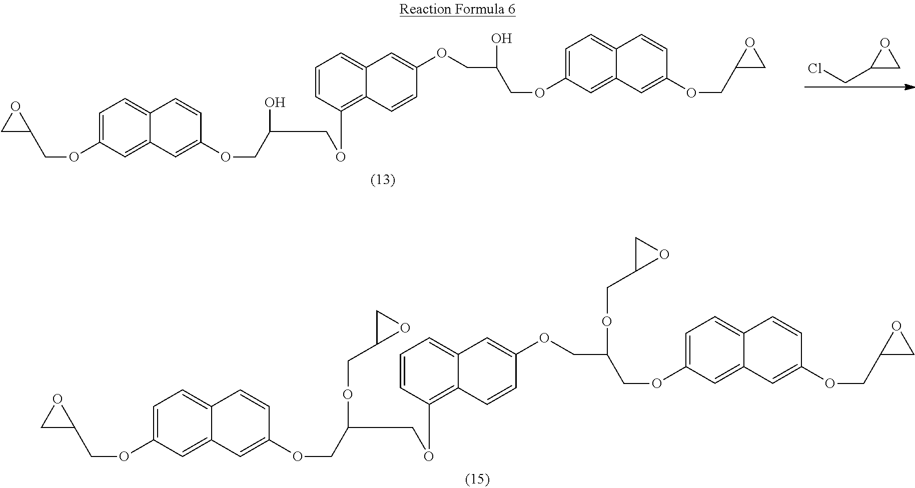

### EXAMPLE 5

### Cured Product of Epoxy Resin Having Acrylate Side Functional Group and Glass Fiber

2.2 g of the epoxy resin (NET-A) having an acrylate side functional group in Formula 14, which was synthesized in Example 3, 0.29 g of diaminodiphenylmethane (DDM), and 7 g of methyl ethyl ketone (MEK) were mixed at room temperature, and the resulting mixture was stirred to prepare a homogeneous solution. A quartz glass fiber fabric with an amino reactive functional group, having a size of 45 mm×45 mm, was dipped in the solution, and the solvent was dried at 120° C. in a vacuum oven for 10 min. After drying, the fabric was placed into a hot press and cured to prepare a cured product of an epoxy resin having a side acrylate group and a glass fiber (NET-A-GF cured product). Curing reactions were performed under curing conditions in the hot press at 150° C., 200° C., and 230° C., respectively, for 2 hours. The resin was present in an amount of 50% by weight based on the epoxy polymer cured product thus prepared, and the cured product had a thickness of 0.3 mm.

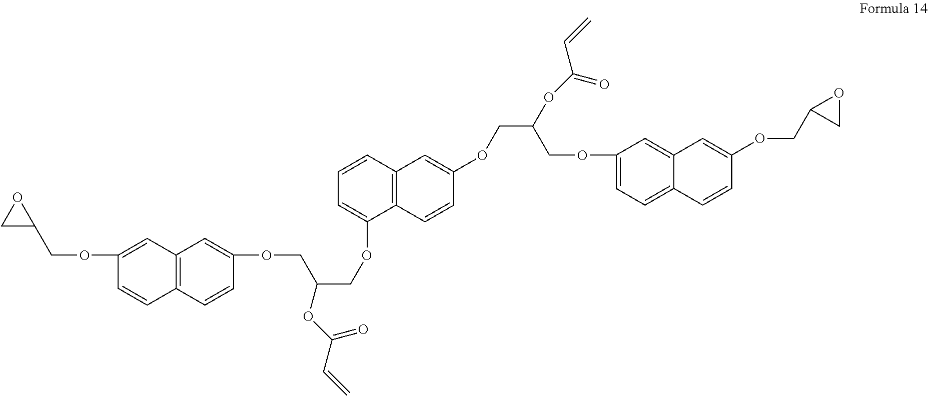

2.2 g of the epoxy (NET-A) having an acrylate side functional group in Formula 14, 0.29 g of DDM, and 7 g of MEK were mixed at room temperature, the resulting mixture was stirred to prepare a homogeneous solution, and the solvent was dried at 120° C. in a vacuum oven for 10 min. After drying, the mixture was placed into a hot press and cured to prepare a cured product of an epoxy resin having an acrylate side functional group (NET-A cured product). Curing reactions were performed under curing conditions in the hot press at 150° C., 200° C., and 230° C., respectively, for 2 hours.

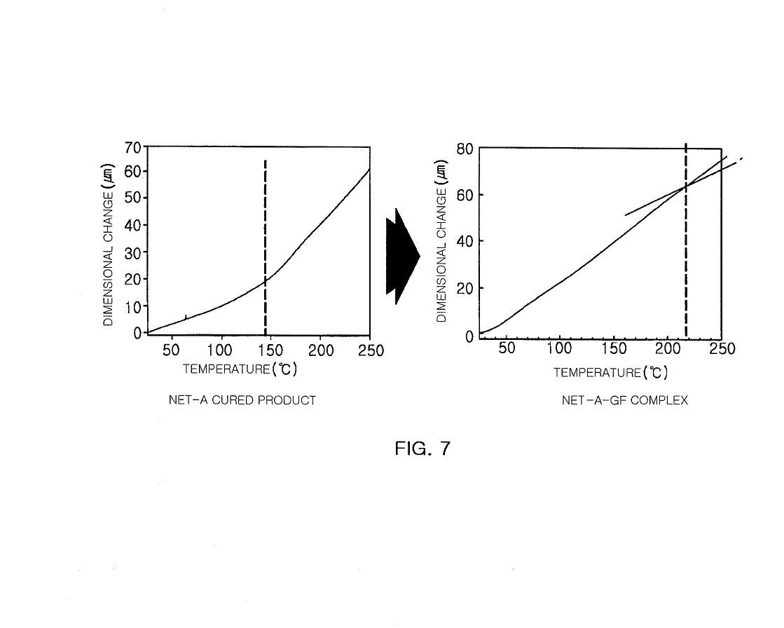

Subsequently, thermal expansion properties of the NET-A-GF cured product and the NET-A cured product were evaluated. As the evaluation of thermal expansion properties, dimensional changes of the NET-A-GF cured product and the NET-A cured product with the temperature were evaluated by using a thermo mechanical analyzer (TMA). A sample of the NET-A-GF cured product was prepared to have a dimension of width×length×thickness of 4 mm×35 mm×0.3 mm, and the measurement was performed in a tension mode. A sample of the NET-A cured product was prepared to have a dimension of width×length×thickness of 5 mm×5 mm×3 mm, the measurement was performed in an expansion mode, and the results are shown in the following FIG. 7 and Table 1.

TABLE 1

| Polymer system | | CTE (ppm/° C.) | | Tg (° C.) |
|---|---|---|---|---|
| Epoxy resin | Curing agent | α1 (T < Tg) | α2 (T > Tg) | (TMA) |
| NET-A | DDM | 56 | 149 | 150 |
| cured product | | | | |
| NET-A-GF | DDM | 15 | 11 | 220 |
| cured product | | | | |

As shown in FIG. 7 and Table 1, a cured product of an epoxy resin having an acrylate side functional group and a glass fiber fabric (NET-A-GF cured product) had a glass transition temperature which was increased by about 70° C. as compared to that of the epoxy resin cured product (NET-A cured product). Thus, the NET-A-GF cured product exhibits improved thermal expansion properties (that is, excellent dimensional stability) and excellent strength at high temperature, compared to the NET-A cured product. In addition, it was confirmed from FIG. 7 that dimensional change of glass fiber composite was decreased with the change of temperature from room temperature to high temperature (>200° C.).

### EXAMPLE 6

### Cured Product of Epoxy Resin Having Epoxy Side Functional Group and Glass Fiber

2.1 g of the epoxy resin (NET-epoxy) having an epoxy side functional group in Formula 15, synthesized in Example 4, 0.5 g of DDM, and 7 g of MEK were mixed at room temperature, the resulting mixture was stirred to prepare a homogeneous solution, in which a quartz glass fiber fabric (45 mm×45 mm dimension) having an amino reactive functional group was dipped, and then the solvent was dried at 120° C. in a vacuum oven for 10 min. After drying, the fabric was placed into a hot press and cured to prepare a cured product of an epoxy resin having an epoxy side functional group and a glass fiber fabric (NET-Epoxy-GF composite). Curing reactions were performed under curing conditions in the hot press at 150° C., 200° C., and 230° C., respectively, for 2 hours. The resin was present in an amount of 50% by weight based on the epoxy polymer cured product thus prepared, and the cured product had a thickness of 0.3 mm.

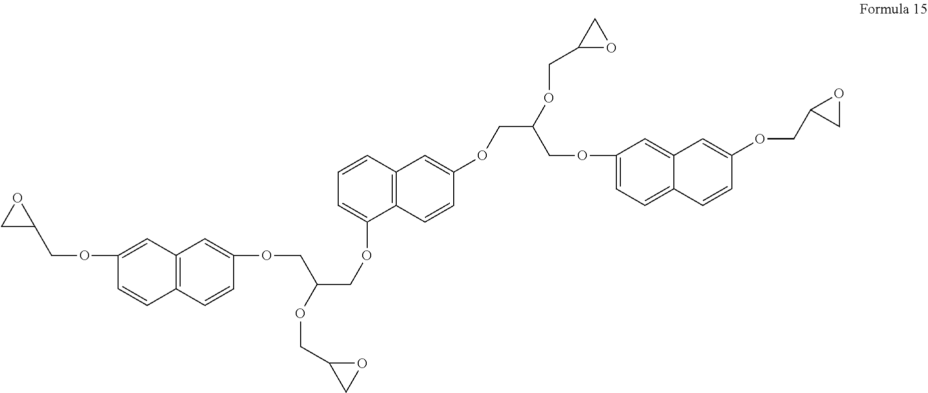

2.1 g of the epoxy resin (NET-epoxy) having an epoxy side functional group in the above Formula 15, 0.5 g of DDM, and 7 g of MEK were mixed at room temperature, the resulting mixture was stirred to prepare a homogeneous solution, and the solvent was dried at 120° C. in a vacuum oven for 10 min. After drying, the mixture was placed into a hot press and cured to prepare an epoxy resin cured product (NET-Epoxy cured product). Curing reactions were performed under curing conditions in the hot press at 150° C., 200° C., and 230° C., respectively, for 2 hours.

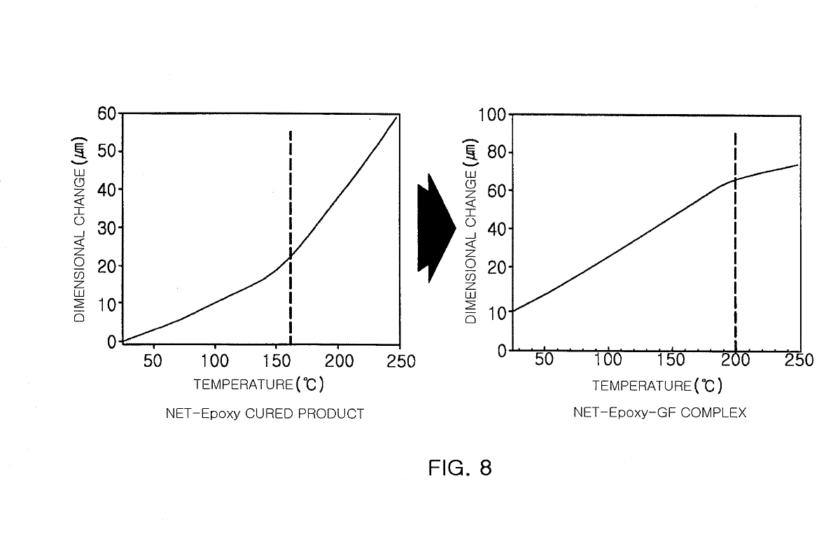

Subsequently, thermal expansion properties of the NET-Epoxy-GF cured product and the NET-epoxy cured product were evaluated in the same manner as in Example 5, and are shown in the following FIG. 8 and Table 2.

TABLE 2

| Polymer system | | CTE (ppm/° C.) | | Tg (° C.) |
|---|---|---|---|---|
| Epoxy resin | Curing agent | α1 (T < Tg) | α2 (T > Tg) | (TMA) |
| NET-Epoxy | DDM | 52 | 149 | 160 |
| cured product | | | | |
| NET-Epoxy-GF | DDM | 16 | 7.2 | 200 |
| cured product | | | | |

As shown in FIG. 8 and Table 2, a composite cured product with a glass fiber fabric (NET-Epoxy-GF cured product) had a glass transition temperature which was increased by about 40° C. as compared to that of the epoxy resin cured product (NET-Epoxy cured product). Thus, the NET-Epoxy-GF cured product exhibits improved thermal expansion properties and excellent strength at high temperature, compared to the NET-epoxy cured product. In addition, it was confirmed from FIG. 8 that the dimensional change of glass fiber composite was decreased with the change of temperature from room temperature to high temperature (>200° C.).

### COMPARATIVE EXAMPLE 3

### Preparation of Epoxy/Glass Fiber Fabric Cured Product Using Diglycidyl Ether of Bisphenol A (DGEBA)

2.0 g of diglycidyl ether of bisphenol A (DGEBA, Mn: 377), 0.52 g of DDM, and 7 g of MEK were mixed at room temperature, the resulting mixture was stirred to prepare a homogeneous solution, in which a glass fiber fabric (45 mm×45 mm dimension) having amino reactive functional group was dipped, the solvent was dried at 120° C. in a vacuum oven for 10 min, and the fiber was cured in a hot press under the same conditions and in the same manner as in Example 5 (curing conditions: cured at 150° C., 200° C., and 230° C., respectively, for 2 hours) to prepare a cured product of an epoxy resin and a glass fiber fabric (DGEBA-GF cured product).

2.0 g of DGEBA, 0.52 g of DDM, and 7 g of MEK were mixed, the resulting mixture was stirred to prepare a homogeneous solution, and the solution was dried at 120° C. for 10 min. After drying, the mixture was placed into a hot press and cured under the same conditions and in the same manner as in Example 5 (curing conditions: cured at 150° C., 200° C., and 230° C., respectively, for 2 hours) to prepare an epoxy resin cured product (DGEBA cured product).

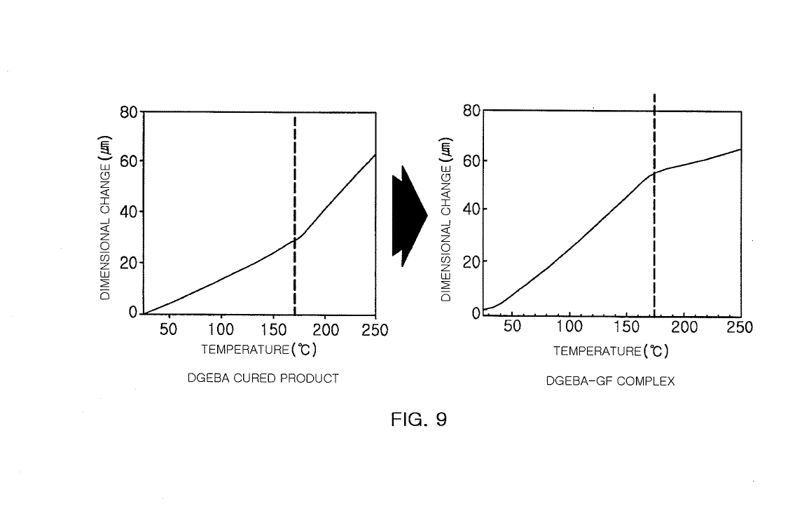

Subsequently, thermal expansion properties of the DGEBA-GF cured product and the DGEBA cured product were evaluated in the same manner as in Example 5, and are shown in the following FIG. 9 and Table 3.

TABLE 3

| Polymer system | | CTE (ppm/° C.) | | Tg (° C.) |
|---|---|---|---|---|
| Epoxy resin | Curing agent | α1 (T < Tg) | α2 (T > Tg) | (TMA) |
| DGEBA cured | DDM | 70 | 166 | 166 |
| product | | | | |
| DGEBA-GF | DDM | 16 | 4.5 | 170 |
| cured product | | | | |

As shown in FIG. 9 and Table 3, the glass transition temperature of the DGEBA-GF cured product was observed to be similar to that of the DGEBA cured product. From the observation, when an epoxy resin which was not modified or did not have a specific core structure according to the present invention was used, it was confirmed that even though a composite with a glass fiber fabric was formed, thermal expansion properties and strength properties of the composite at high temperature were not improved sufficiently.

### EXAMPLE 7

### Evaluation of Strength Properties

The dynamic mechanical properties of the cured product of an epoxy resin and a glass fiber fabric prepared in Examples 5 and 6 were evaluated by using a dynamic mechanical analyzer (DMA, TA Instrument, DMA2980). A sample had a dimension of 12.5 mm×40 mm×2 mm, and the measurement was performed in Dual Cantilever Mode. The measurement was performed in a temperature range of 25 to 250° C., at a heating rate of 5° C./min, and at a frequency of 1 Hz.

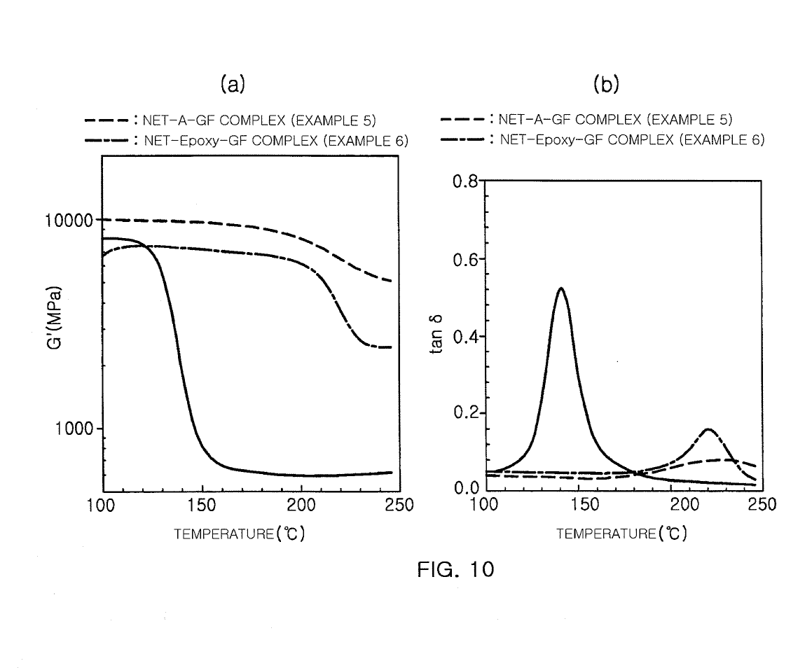

As shown with a solid line in FIG. 10(a), a typical epoxy resin cured product (DGEBA) had significantly decreased storage modulus values (G′) at temperature above the glass transition temperature. As shown with a solid line in FIG. 10(b), a peak tan δ value was also shown at the glass transition temperature. A decrease in storage modulus means a decrease in strength. However, as confirmed from changes in peak tan δ values in FIG. 10(b), the NET-A-GF composition in Example 5 and the NET-epoxy-GF composite in Example 6 exhibited greatly improved thermal properties and strengths, such as increased glass transition temperatures and high storage moduli (G′) at high temperature. As known from the tan δ result, these physical properties are due to the fact that a composite of an epoxy resin modified by a reactive functional group and a glass fiber fabric having an amine group greatly inhibits the glass transition behavior and increases the glass transition temperature.

### EXAMPLE 8

### Preparation of Epoxy Resin Having Acrylate Side Functional Group

10 g of diglycidyl ether of bisphenol A (DGEBA, Mn: 1075) (16) was added to 120 Ml of methylene chloride in a 250 Ml flask at room temperature and the resulting solution was stirred. 10 Ml of diisopropyl ethylamine was added to the solution at 0° C., and immediately 9 Ml of acryloyl chloride was slowly added to the resulting mixture. The mixture was left to react at 0° C. for 2 hours, and then the organic layer was worked up with brine. The remaining water in the organic layer was removed with MgSO4, and then the resulting mixture was evaporated to remove the solvent and obtain an epoxy resin 18 having an acrylate group. The reaction formula of the modifying reaction is shown in the following Reaction Formula 7.

1H NMR (400 MHz, DMSO-d6) 8 7.09 (m, 12 H), 6.84 (m, 12 H), 6.34 (dd, J=15.0, 1.5 Hz, 2H), 6.20 (dd, J=17.0, 10.5 Hz, 2H), 5.97 (dd, J=10.5, 1.5 Hz, 2H), 5.46 (m, 2H), 4.24 (m, 10H), 3.77 (dd, 3=11.0, 6.5 Hz, 2H), 3.30 (m, 2H), 2.82 (dd, J=5.0, 4.5 Hz, 2H), 2.68 (dd, 3=5.0, 2.5 Hz, 2H), 1.56 (S, 18H).

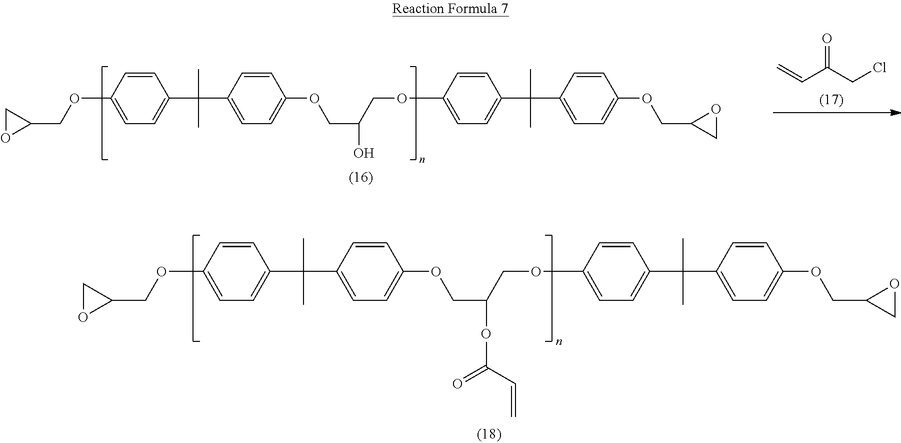

### EXAMPLE 9

### Composite of Epoxy Resin Having Acrylate Side Functional Group and Inorganic Particles

2.5 g of the epoxy resin having an acrylate side functional group, obtained in Example 8, and 0.9 g of silica particles (average particle size: 1 μm) having an amino functional group on the surface thereof were dissolved in 30 g of methylene chloride at room temperature, and then the resulting solution was uniformly mixed by using a mixer. 0.87 g of diaminodiphenylmethane (DDM) was added to the mixture, and mixed by using a mini-shaker to prepare a homogeneous solution. The solution thus prepared was placed into a vacuum oven preheated to 120° C. to remove the solvent, and the resulting mixture was poured into a mold preheated to 120° C. The polymer composite was subjected to curing reaction at 150° C. for 2 hours and followed by further curing reaction at 200° C. for 2 hours by increasing the temperature of the oven.

Thermal expansion properties of the epoxy composite obtained in the present Example were evaluated in a temperature range from room temperature to 200° C. at a heating rate of 5° C./min by using a thermal mechanical analyzer (TMA).

As a result, the CTE of the modified epoxy resin composite was about 45 ppm/° C., which was much better than 58 ppm/° C., which was that of the composite in Comparative Example 4 to be described below, meaning that the former has excellent thermal resistance.

### COMPARATIVE EXAMPLE 4

### Composite of Epoxy Resin Having No Specific Side Functional Group and Inorganic Particles

A composite was prepared in the same manner as in Example 9, except that diglycidyl ether of bisphenol A (DGEBA, Mn: 1075) as an epoxy resin and silica particles which didn't have a reactive functional group on the surface thereof were used.

Thermal expansion properties of the epoxy composite obtained in Comparative Example 4 were evaluated in a temperature range from room temperature to 200° C. at a heating rate of 5° C./min by using a thermal mechanical analyzer (TMA). As a result, the CTE of the epoxy resin composite was about 58 ppm/° C.

### EXAMPLE 10

### Synthesis of Naphthalene-Cardo-Naphthalene Trimer Epoxy Resin

11.26 g of 9,9-bis(4-hydroxyphenyl)fluorene, 35 g of 1,6-diepoxy naphthalene, 0.88 g of tetraethylbenzylammonium chloride (TEBAC), and 70 Ml of acetonitrile were put into a 250 Ml flask, and the resulting mixture was stirred at 80° C. 9,9-Bis(4-hydroxyphenyl)fluorene and 1.6-diepoxy naphthalene were completely dissolved, and then a reaction was performed at 80° C. for 12 hours. After the reaction was completed, the solvent was removed with an evaporator, and then the resulting mixture was dissolved in 200 Ml of ethyl acetate and worked up with H2O. The organic layer was separated, and ethyl acetate was removed with an evaporator to obtain an epoxy resin including a naphthalene-based unit and a cardo-based unit. The synthetic reaction formula of a new epoxy resin according to Example 10 is shown in the following Reaction Formula 8.

1H NMR (400 MHz, CDCl3) δ 8.19 (d, J=9.2 Hz, 1H), 8.11 (d, J=16.0 Hz, 1H), 7.74 (d, J=7.2 Hz, 2H), 7.35-7.26 (m, 8H), 7.25-7.23 (m, 2H), 7.16-7.09 (m, 8H), 6.79 (d, J=8.4 Hz, 4H), 6.71-6.66 (m, 2H), 4.48-4.03 (m, 14H), 3.49-3.39 (m, 2H), 2.96-2.92 (m, 2H), 2.84-2.78 (m, 2H).

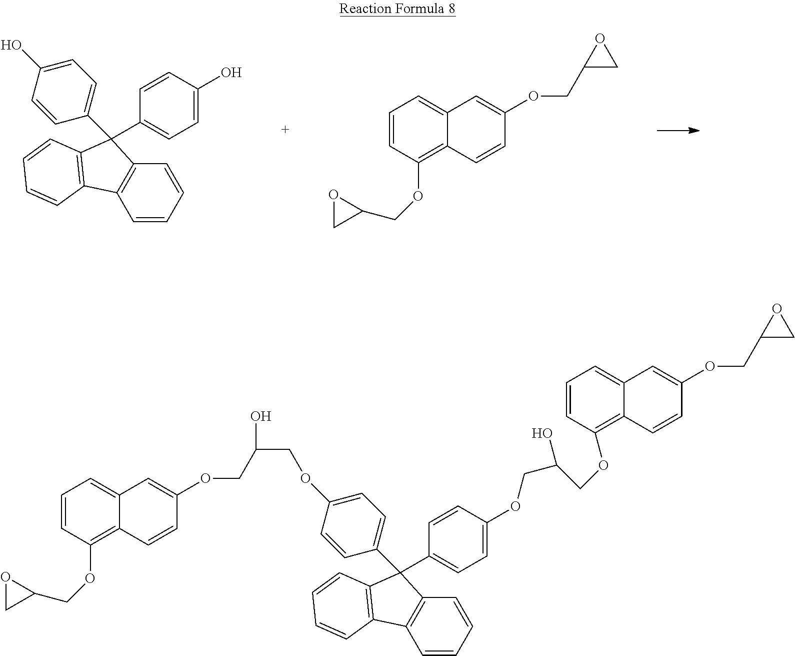

### EXAMPLE 11

### Synthesis of Cardo-Naphthalene-Cardo Trimer Epoxy Resin

57.7 g of a cardo-epoxy monomer and 0.85 g of triethyl benzyl ammonium chloride were put into a flask, and air in the reaction vessel was removed to create a vacuum. 300 Ml of CH3CN was added to the flask and stirred at room temperature for 5 min to obtain a homogeneous solution. A naphthalene solution of 5 g of dihydroxyl naphthalene dissolved in 100 Ml of CH3CN was slowly added dropwise to the above-mentioned solution, and the resulting solution was left to react at 80° C. for 24 hours. The solvent was removed with an evaporator, and the resulting mixture was dissolved in 200 MP of ethyl acetate and worked up with H2O. The organic layer was separated, and ethyl acetate was removed with an evaporator to obtain an epoxy resin including a naphthalene-based unit and a cardo-based unit in the main chain. The synthetic reaction formula of a new epoxy resin according to Example 11 is shown in the following Reaction Formula 9.

1H NMR (400 MHz, CDCl3) δ 8.10 (d, J=10.0 Hz, 1H), 7.74 (d, J=7.2 Hz, 4H), 7.34-7.30 (m, 11H), 7.25-7.23 (m, 2H), 7.11-7.09 (m, 11H), 6.77 (q, J=8.8 Hz, 8H), 6.70 (dd, J=5.8, 2.6 Hz, 1H), 4.49-4.39 (m, 2H), 4.29-4.12 (m, 10H), 3.92-3.88 (m, 2H), 3.30 (s, 1H), 2.88-2.86 (m, 2H), 2.71-2.70 (m, 2H), 2.59-2.56 (m, 2H).

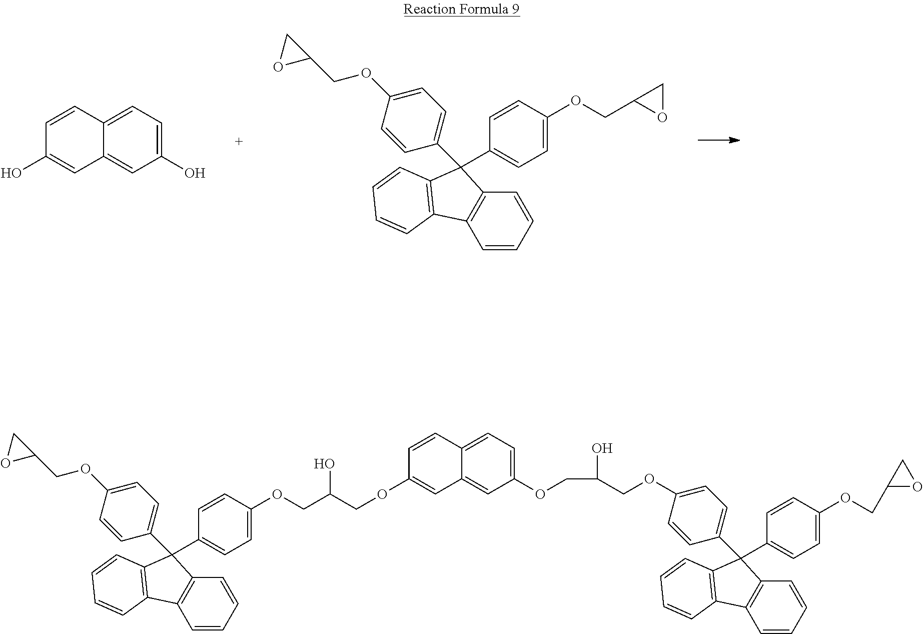

EXAMPLE 12

### Synthesis of Naphthalene-Cardo-Naphthalene Trimer Epoxy Resin Having Specific Side Functional Group

5 g of the trimer synthesized in Example 10 was put into 60 Ml of methylene chloride in a 250 Ml flask at room temperature, and the resulting solution was stirred. 3 Ml of triethyl amine and 1.8 Ml of acryloyl chloride were slowly added to the solution at 0° C., and the resulting mixture was left to react at 0° C. for 2 hours. After the reaction was completed, the mixture was quenched with saturated NaHCO3, and the organic layer was worked up with water. The organic layer was separated, the remaining water in the organic layer was removed with MgSO4, the resulting organic layer was filtered, and then the solvent was removed with an evaporator. The synthetic reaction formula of a new epoxy resin according to Example 12 is shown in the following Reaction Formula 10.

1H NMR (400 MHz, CDCl3) δ 8.17 (d, J=9.0 Hz, 1H), 8.13 (d, J=16.0 Hz, 1H), 7.72 (d, J=7.0 Hz, 2H), 7.4-7.2 (m, 8H), 7.3-7.2 (m, 2H), 7.16-7.09 (m, 8H), 6.79 (d, J=8.4 Hz, 4H), 6.7-6.66 (m, 2H), 6.50 (d, J=17.2 Hz, 2H), 6.20 (q, J=10.0 Hz, 2H), 5.89 (d, J=10.4 Hz, 2H), 4.48-4.03 (m, 14H), 3.49-3.39 (m, 2H), 2.96-2.92 (m, 2H), 2.84-2.78 (m, 2H).

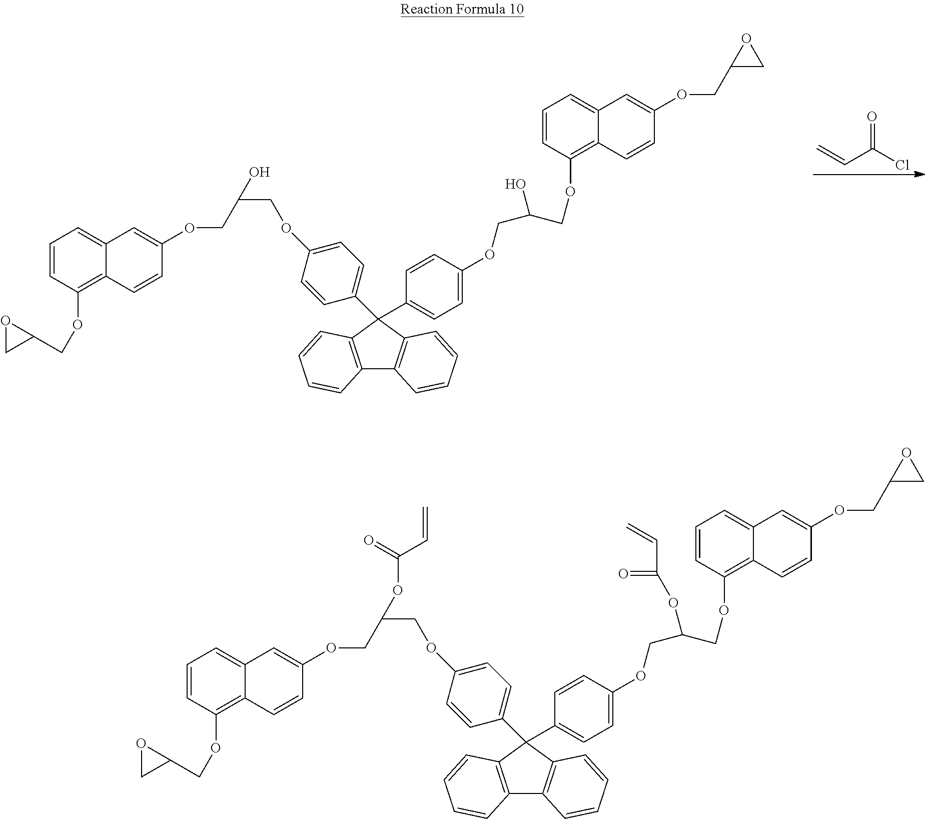

### EXAMPLE 13

### Curing of Naphthalene-Cardo-Naphthalene Trimer Epoxy Resin Composition

1.6 g of the naphthalene-cardo-naphthalene epoxy resin prepared in Example 10 and 0.189 g of diaminodiphenylmethane (DDM) were dissolved in 7 g of methylene chloride at room temperature, and the resulting solution was uniformly mixed by using a mixer. The solution prepared was placed into a vacuum oven preheated to 90° C. to remove the solvent, the resulting mixture was placed into a mold preheated to 90° C., left to react at 90° C. for 2 hours, at 150° C. for 2 hours, and at 200° C. for 2hours sequentially, and followed by at 230° C. for further 2 hours by increasing the temperature of the oven to be cured.

### EXAMPLE 14

### Curing of Cardo-Naphthalene-Cardo Trimer Epoxy Resin Composition

2.5 g of the cardo-naphthalene-cardo epoxy resin prepared in Example 11 and 0.87 g of DDM were dissolved in 7 g of methylene chloride at room temperature, and the resulting solution was uniformly mixed by using a mixer. The solution prepared was placed into a vacuum oven preheated to 90° C. to remove the solvent, the resulting mixture was placed into a mold preheated to 90° C., left to react at 90° C. for 2 hours, at 150° C. for 2 hours, and at 200° C. for 2 hours sequentially, and followed by at 250° C. for further 2 hours by increasing the temperature of the oven to be cured.

### EXAMPLE 15

### Curing of Naphthalene-Cardo-Naphthalene Trimer Epoxy Resin Composition Having Specific Side Functional Group

1.75g of the naphthalene-cardo-naphthalene epoxy resin prepared in Example 12 and 0.189 g of DDM were dissolved in 5g of methylene chloride at room temperature, and the resulting solution was uniformly mixed by using a mixer. The solution prepared was placed into a vacuum oven preheated to 90° C. to remove the solvent, the resulting mixture was placed into a mold preheated to 90° C., left to react at 90° C. for 2 hours, at 150° C. for 2 hours, and at 200° C. for 2 hours sequentially, and followed at 250° C. for further 2 hours by increasing the temperature of the oven to be cured.

### EXAMPLE 5

### Curing of Naphthalene Epoxy Resin Composition

2 g of 1,6-diepoxy naphthalene resin was melted in an oven preheated to 120° C., and then 0.728 g of DDM was added to the resin and mixing was performed for 2 to 3 min. The homogeneously mixed solution was placed into a mold preheated to 120° C., left to react at 120° C. for 2 hours and at 150° C. for 2 hours, and followed by at 200° C. for further 2 hours by increasing the temperature of the oven to be cured.

### EXAMPLE 16

### Evaluation of Thermal Properties of Cured Product

Thermal properties of the cured products in Examples 13 to 15 and Comparative Example 5 were evaluated. As the evaluation of thermal expansion properties, dimensional changes of the cured products according to the temperature were evaluated by using a thermo-mechanical analyzer (TMA). Samples of the cured products were prepared to have a dimension of width×length×thickness of 5 mm×5 mm×3 mm, and the measurements were performed in an expansion mode. The results are shown in the following Table 4.

TABLE 4

| Cured product system | | CTE (ppm/° C.) | Tg (° C.) |
|---|---|---|---|
| Epoxy resin | Curing agent | α1 (T < Tg) | (TMA) |
| Example 13 | DDM | 43 | 199 |
| Example 14 | DDM | 40 | 225 |
| Example 15 | DDM | 47 | 195 |
| Comparative Example 5 | DDM | 55 | 175 |

As shown in the Table 4, it was confirmed that a cured product of an epoxy resin including a cardo unit according to the present invention had a glass transition temperature which was higher by about 20 to 40° C. as compared to that of a naphthalene epoxy cured product in Comparative Example 5, and had a decreased dimensional change according to the temperature change.

### EXAMPLE 17

### Preparation of Resin Composite Using New Epoxy Resin

1.6 g of the naphthalene-cardo-naphthalene epoxy resin synthesized in Example 10, 0.5 g of DDM, and 7 g of MEK were mixed at room temperature, the resulting mixture was stirred to prepare a homogeneous solution, in which a quartz glass fiber fabric (45 mm×45 mm dimension) having an amino group was dipped, and then the solvent was dried at 120° C. in a vacuum oven for 10 min. After drying, the fabric was placed into a hot press and cured to prepare a composite of an epoxy resin modified by an epoxy group and a glass fiber fabric. Curing reactions were performed under curing conditions in the hot press at 150° C., 200° C., 230° C., and 250° C., respectively, for 2 hours. Subsequently, thermal properties of the composite were evaluated in the same manner as in Example 16, and as a result, a CTE value of 12 ppm./° C. and a glass transition temperature of 200° C. were obtained, indicating that the composite has excellent thermal properties. The resin was present in an amount of 50% by weight based on the epoxy polymer composite thus prepared, and the composite had a thickness of 0.3 mm.

### EXAMPLE 18

### Preparation of Resin Composite Using New Epoxy Resin

1.6 g of the naphthalene-cardo-naphthalene epoxy resin synthesized in Example 10, 0.5 g of DDM, 0.5 g of silica particles (average particle size: 1 tm) having an amino group, and 7 g of methyl ethyl ketone (MEK) were mixed at room temperature, the resulting mixture was stirred to prepare a homogeneous solution, and the solvent was dried at 120° C. in a vacuum oven for 10 min. After drying, the mixture was placed into a hot press and cured to prepare a composite of an epoxy resin modified by an epoxy group and inorganic particles. Curing reactions were performed under curing conditions in the hot press at 150° C., 200° C., 230° C., and 250° C., respectively, for 2 hours. Subsequently, thermal properties of the composite were evaluated in the same manner as in Example 16, and as a result, a CTE value of 35 ppm/° C. and a glass transition temperature of 200° C. were obtained, indicating that the composite has excellent thermal properties.

1. An epoxy resin of the following Formula 1, 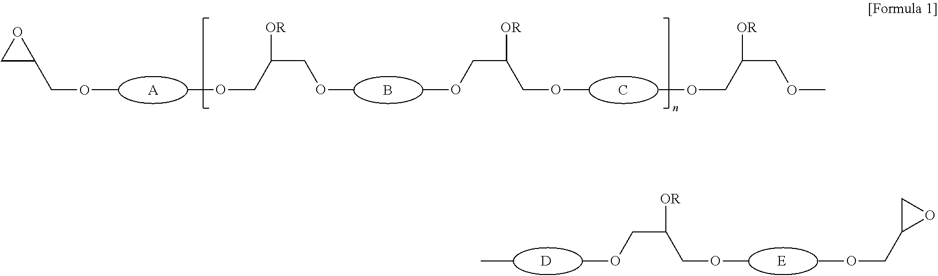
(where core structures A to E are each independently selected from the group consisting of a bisphenol A-based structure, a biphenyl-based structure, a naphthalene-based structure, a cardo-based structure, an anthracene-based structure, a dicyclopentadiene-based structure, a polyaromatic structure, and a liquid crystal-based compound structure, and are identical to or different from each other, and a side functional group R in this case is selected from the group consisting of an epoxy group, a vinyl group, an allyl group, a carboxyl group, an acid anhydride group, 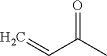
(the terminals thereof are connected), and 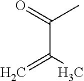
(the terminals thereof are connected); or
the core structures of A, C, and E are identical to each other and the core structures of B and D are identical to each other, the core structures of A, C, and E and the core structures of B and D are different, each being independently selected from the group consisting of a bisphenol A-based structure, a biphenyl-based structure, a naphthalene-based structure, a cardo-based structure, an anthracene-based structure, a dicyclopentadiene-based structure, a polyaromatic structure, and a liquid crystal-based compound structure, and a side functional group R in this case is selected from the group consisting of hydrogen, an epoxy group, a vinyl group, an allyl group, a carboxyl group, an acid anhydride group, 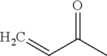
(the terminals thereof are connected), and 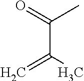
(the terminals thereof are connected); and n is an integer of 0 to 100).

2. The epoxy resin of claim 1, wherein the core structures of A, C, and E are identical to each other, the core structures of B and D are identical to each other in Formula 1, and the core structures of A, C, and E and the core structures of B and D are different from each other and naphthalene-based units.

3. The epoxy resin of claim 2, wherein the epoxy resin is represented by the following Formula 2, 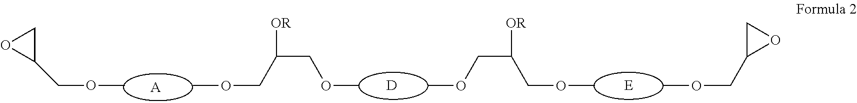
(where the core structures of A and E are naphthalene units identical to each other, the core structure of D is a naphthalene unit different from the naphthalene units of A and E, and a side functional group R is selected from the group consisting of hydrogen, an epoxy group, a vinyl group, an allyl group, a carboxyl group, an acid anhydride group, 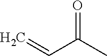
(the terminals thereof are connected), and 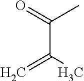
(the terminals thereof are connected).)

4. The epoxy resin of claim 3, wherein the naphthalene-based unit is represented by the following Formula (1-5) or (1-6), 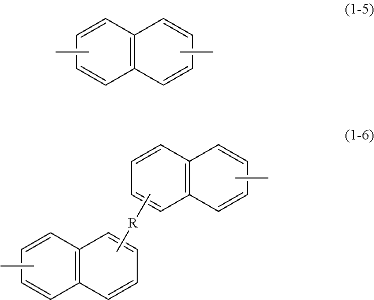
(where R in Formula 1-6 is a simple bond or a C1 to C5 alkanediyl group.)

5. The epoxy resin of claim 4, wherein the naphthalene units different from each other are 1,6-naphthalene and 2,7-naphthalene.

6. The epoxy resin of claim 1, wherein the core structures of A, C, and E are identical to each other, the core structures of B and D are identical to each other in Formula 1, and one structure of the core structures of A, C, and E and the core structures of B and D is a naphthalene-based unit of the following Formula (1-5) or (1-6) and the other is a cardo-based unit selected from the group consisting of the following Formulas (1-7) to (1-12), 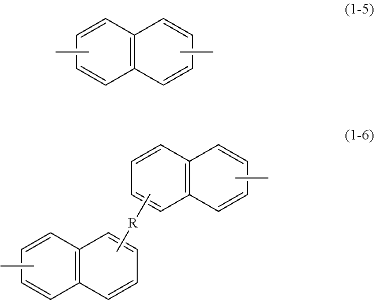
(where R in Formula 1-6 is a simple bond or a C1 to C5 alkanediyl group.)

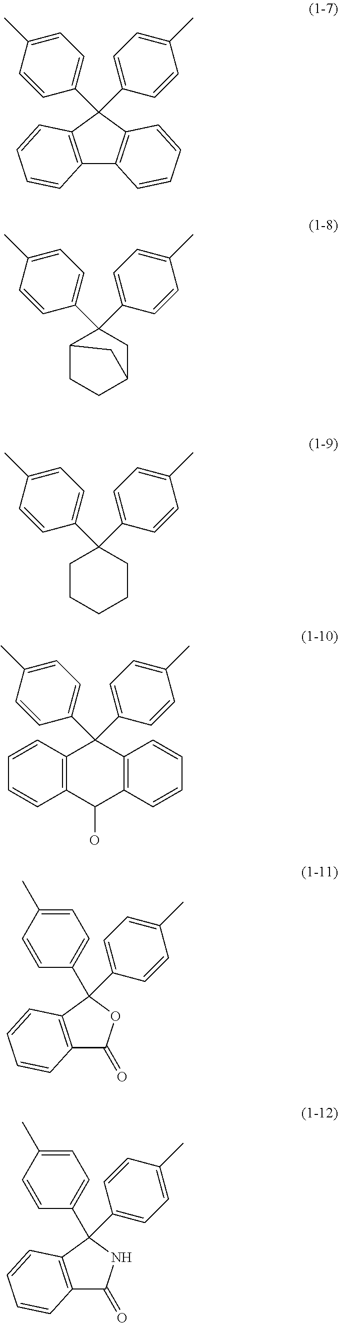

7. An epoxy resin composition comprising:
an epoxy resin of claim 1;
a curing agent; and
at least one filler selected from the group consisting of inorganic particles and a fiber.

8. The epoxy resin composition of claim 7, wherein the inorganic particles is at least one selected from a group consisting of SiO₂, ZrO₂, TiO₂, BaTiO₃, Al₂O₃, a mixture thereof, T-10 type silsesquioxane, cage type silsesquioxane, and ladder type silsesquioxane in alone or in a mixture of two or more thereof.

9. The epoxy resin composition of claim 7, wherein the fiber is a glass fiber selected from the group consisting of E, T(S), NE, E, D, and quartz, or an organic fiber selected from the group consisting of liquid crystal polyester fibers, polyethylene terephthalate fibers, wholly aromatic fibers, and polyoxybenzazole fibers.

10. The epoxy resin composition of claim 7, wherein the filler has at least one functional group selected from the group consisting of an epoxy group, an amino group, a (meth)acrylate group, a C₂ to C₆ alkylene group, an allyl group, a thiol group, and an imidazole group.

11. The epoxy resin composition of claim 7, wherein the filler additionally comprises at least one compatible functional group selected from the group consisting of a C₁ to C₁₀ alkyl, a C₂ to C₁₀ alkylene, a C₃ to C₈ aryl or arylene, a C₁ to C₁₀ alkoxy group, a C₃ to C₈ aromatic alkyl, a C₃ to C₈ aromatic alkoxy, a C₃ to C₇ hetero aromatic alkoxy group (the hetero element is at least one selected from the group consisting of O, N, S, and P), a C₃ to C₇ hetero aromatic alkyl (the hetero element is at least one selected from the group consisting of O, N, S, and P), a (meth)acrylate group, a vinyl group, an allyl group, a thiol group, and a maleimide group.

12. An article comprising the thermosetting resin composition of claim 7.

13-14. (canceled)
